(19) United States
(12) Patent Application Publication
(10) Pub. No.: US 2014/0341085 A1
(43) Pub. Date: Nov. 20, 2014

(54) SELECTING AN APPLICATION SERVER AT WHICH TO REGISTER ONE OR MORE USER EQUIPMENTS FOR AN INTERNET PROTOCOL MULTIMEDIA SUBSYSTEM (IMS) SESSION

(71) Applicant: QUALCOMM INCORPORATED, San Diego, CA (US)

(72) Inventors: Vijay A. Suryavanshi, San Diego, CA (US); James M. Lin, San Diego, CA (US); Mohammed Ataur Rahman Shuman, San Diego, CA (US)

(73) Assignee: QUALCOMM INCORPORATED, San Diego, CA (US)

(21) Appl. No.: 13/893,662

(22) Filed: May 14, 2013

(51) Int. Cl. H04W 8/04; H04W 4/08

(52) U.S. Cl. CPC H04W 8/04; H04W 4/08
USPC 370/260

(57) ABSTRACT

In an embodiment, an Internet Protocol (IP) multimedia subsystem (IMS) network that is operated by a single operator receives a request from a user equipment (UE) for registering to a group IMS session. The IMS network determines a location region where the UE is located and identifies a single application server deployed in the location region at which to register UEs that are located in the location region and request registration to the group IMS session. In another embodiment, an application server deployed in a first location region receives a request to register a UE to an IMS session from the IMS network. The application server selectively redirects the registration for the UE either to (i) an application server deployed in a second location region, or (ii) another application server deployed in the first location region.

### BACKGROUND OF THE INVENTION

1. Field of the Invention

Embodiments of the invention relate to selecting an application server at which to register one or more user equipments for an Internet Protocol (IP) multimedia subsystem (IMS) session.

2. Description of the Related Art

Wireless communication systems have developed through various generations, including a first-generation analog wireless phone service (1G), a second-generation (2G) digital wireless phone service (including interim 2.5G and 2.75G networks) and third-generation (3G) and fourth-generation (4G) high speed data/Internet-capable wireless services. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

More recently, Long Term Evolution (LTE) has been developed as a wireless communications protocol for wireless communication of high-speed data for mobile phones and other data terminals. LTE is based on GSM, and includes contributions from various GSM-related protocols such as Enhanced Data rates for GSM Evolution (EDGE), and Universal Mobile Telecommunications System (UMTS) protocols such as High-Speed Packet Access (HSPA).

Access networks using various communication protocols (e.g., 3GPP access networks such as W-CDMA, LTE, etc., or non-3GPP access networks such as WiFi, WLAN or wired LAN, etc.) can be configured to provide Internet Protocol (IP) Multimedia Subsystem (IMS) services via an IMS network managed by an operator (e.g., Verizon, Sprint, AT&T, etc.) to users across a communications system. Users that access the IMS network to request an IMS service are assigned to one of a plurality of regional application servers or application server clusters (e.g., groups of application servers that serve the same cluster region) for supporting the requested IMS service. However, a user accessing the IMS network over a non-3GPP access network (e.g., WiFi) can cause the user to be served by an application server that is not proximate to the user's location due in part to difficulties in identifying users connected to non-3GPP access networks. Thus, two users accessing the same IMS network, requesting the same IMS service (e.g., VoIP, PTT, etc.) and are physically co-located may actually be served via different deployment clusters of the application servers. Assigning application servers to users in this manner can increase the complexity of providing the IMS services in terms of pre-processing (e.g., call setup, user lookup, etc.) and post-processing (e.g., billing, CALEA, etc.). Additionally, assigning a non-physically co-located application server to a user increases the backend traffic between the cluster regions as well.

### SUMMARY

In an embodiment, an Internet Protocol (IP) multimedia subsystem (IMS) network that is operated by a single operator receives a request from a user equipment (UE) for registering to a group IMS session. The IMS network determines a location region where the UE is located and identifies a single application server deployed in the location region at which to register UEs that are located in the location region and request registration to the group IMS session. In another embodiment, an application server deployed in a first location region receives a request to register a UE to an IMS session from the IMS network. The application server selectively redirects the registration for the UE either to (i) an application server deployed in a second location region, or (ii) another application server deployed in the first location region.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 illustrates a high-level system architecture of a wireless communications system in accordance with an embodiment of the invention.

FIG. 2A illustrates an example configuration of a radio access network (RAN) and a packet-switched portion of a core network for a 1×EV-DO network in accordance with an embodiment of the invention.

FIG. 2B illustrates an example configuration of the RAN and a packet-switched portion of a General Packet Radio Service (GPRS) core network within a 3G UMTS W-CDMA system in accordance with an embodiment of the invention.

FIG. 2C illustrates another example configuration of the RAN and a packet-switched portion of a GPRS core network within a 3G UMTS W-CDMA system in accordance with an embodiment of the invention.

FIG. 2D illustrates an example configuration of the RAN and a packet-switched portion of the core network that is based on an Evolved Packet System (EPS) or Long Term Evolution (LTE) network in accordance with an embodiment of the invention.

FIG. 2E illustrates an example configuration of an enhanced High Rate Packet Data (HRPD) RAN connected to an EPS or LTE network and also a packet-switched portion of an HRPD core network in accordance with an embodiment of the invention.

FIG. 3 illustrates examples of user equipments (UEs) in accordance with embodiments of the invention.

FIG. 4 illustrates a communication device that includes logic configured to perform functionality in accordance with an embodiment of the invention.

FIG. 5 illustrates a server in accordance with an embodiment of the invention.

FIG. 6 illustrates an example of Internet Protocol (IP) multimedia subsystem (IMS) session architecture in accordance with an embodiment of the invention.

FIG. 7A illustrates a conventional process of setting up an IMS session between two UEs.

FIG. 7B illustrates another conventional process of setting up IMS service between two UEs where the assignment of application servers is based on location.

FIG. 7C illustrates a conventional process of setting up a group IMS session between a group of UEs where the assignment of application servers is based on location.

FIG. 8A illustrates a process of setting up group IMS service between a group of UEs in accordance with an embodiment of the invention.

FIG. 8B illustrates the process of FIG. 8A as it pertains to one of the UEs in the group being implemented over the IMS architecture from FIG. 6 in accordance with an embodiment of the invention.

FIG. 9A illustrates a process of setting up a group IMS session between a group of UEs in accordance with an embodiment of the invention.

FIG. 9B illustrates a continuation of the process of FIG. 9A in accordance with an embodiment of the invention.

FIG. 9C illustrates the process of FIGS. 9A-9B as it pertains to a first UE from the group being implemented over the IMS architecture from FIG. 6 in accordance with an embodiment of the invention.

FIG. 9D illustrates the process of FIGS. 9A-9B as it pertains to a second UE from the group being implemented over the IMS architecture from FIG. 6 in accordance with an embodiment of the invention.

FIG. 10A illustrates a process of setting up a group IMS session between a group of UEs in accordance with another embodiment of the invention.

FIG. 10B illustrates a continuation of the process of FIG. 10A in accordance with an embodiment of the invention.

FIG. 10C illustrates the process of FIGS. 10A-10B as it pertains to a first UE from the group being implemented over the IMS architecture from FIG. 6 in accordance with an embodiment of the invention.

FIG. 10D illustrates the process of FIGS. 10A-10B as it pertains to a second UE from the group being implemented over the IMS architecture from FIG. 6 in accordance with an embodiment of the invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, referred to herein as a user equipment (UE), may be mobile or stationary, and may communicate with a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile terminal”, a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

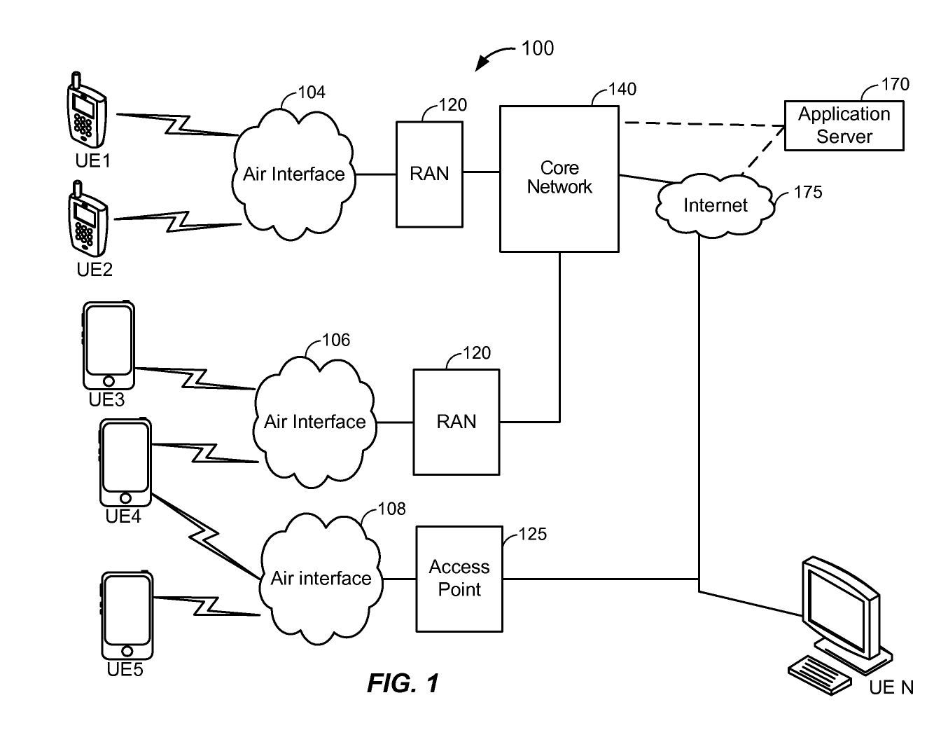

FIG. 1 illustrates a high-level system architecture of a wireless communications system 100 in accordance with an embodiment of the invention. The wireless communications system 100 contains UEs 1 . . . N. The UEs 1 . . . N can include cellular telephones, personal digital assistant (PDAs), pagers, a laptop computer, a desktop computer, and so on. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UE N and UEs 1 . . . N via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, an application server 170 is shown as connected to the Internet 175, the core network 140, or both. The application server 170 can be implemented as a plurality of structurally separate servers, or alternately may correspond to a single server. As will be described below in more detail, the application server 170 is configured to support one or more communication services (e.g., Voice-over-Internet Protocol (VoIP) sessions, Push-to-Talk (PTT) sessions, group communication sessions, social networking services, etc.) for UEs that can connect to the application server 170 via the core network 140 and/or the Internet 175.

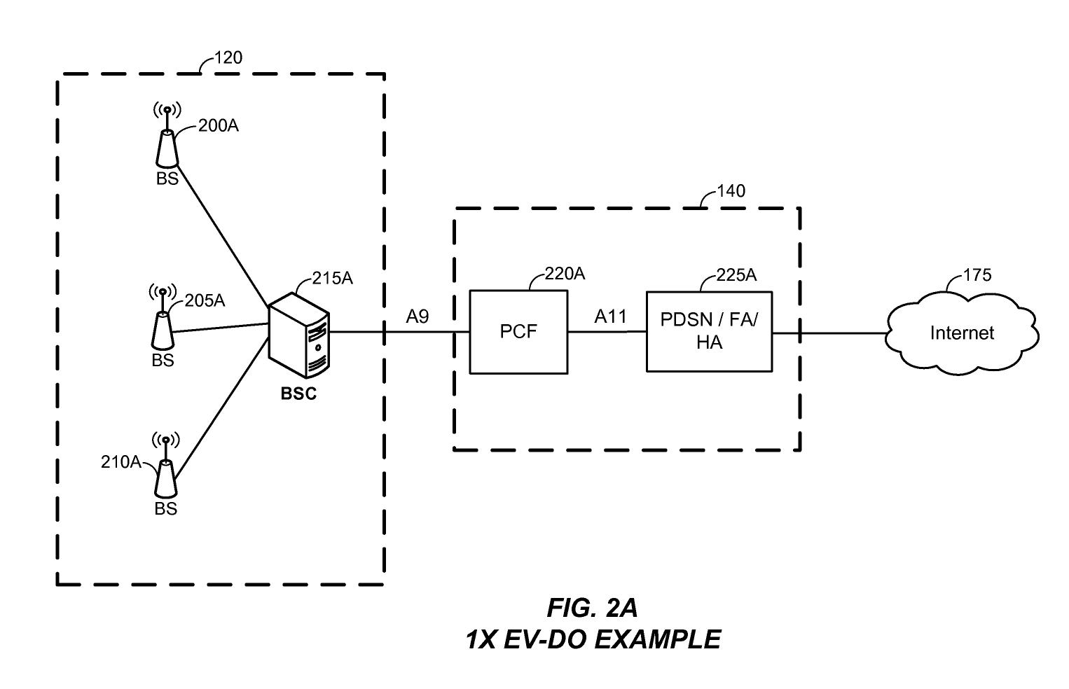

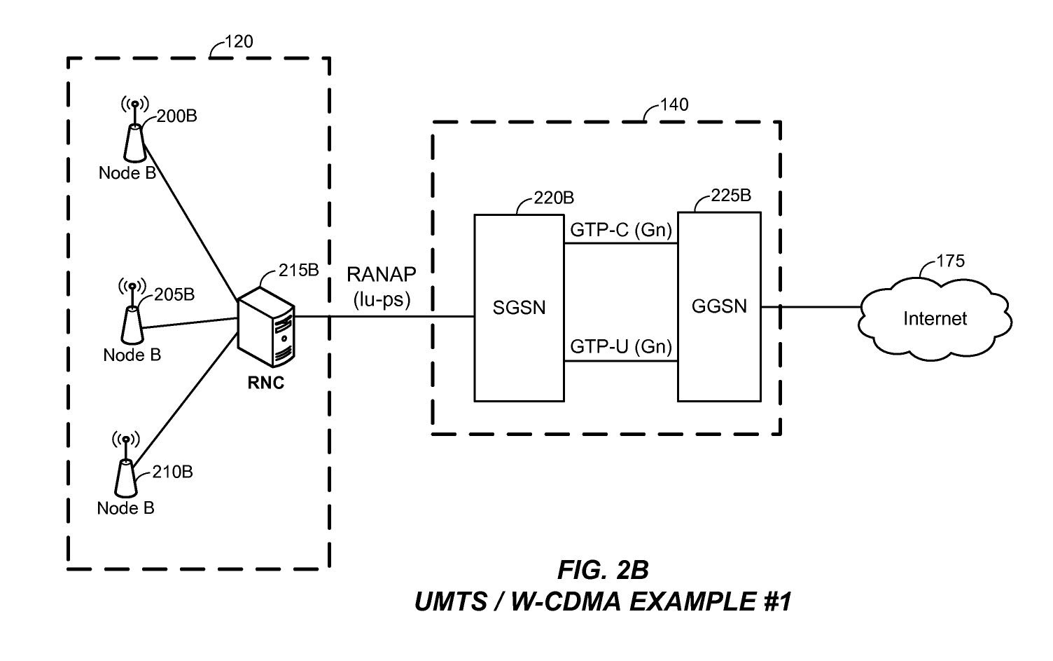

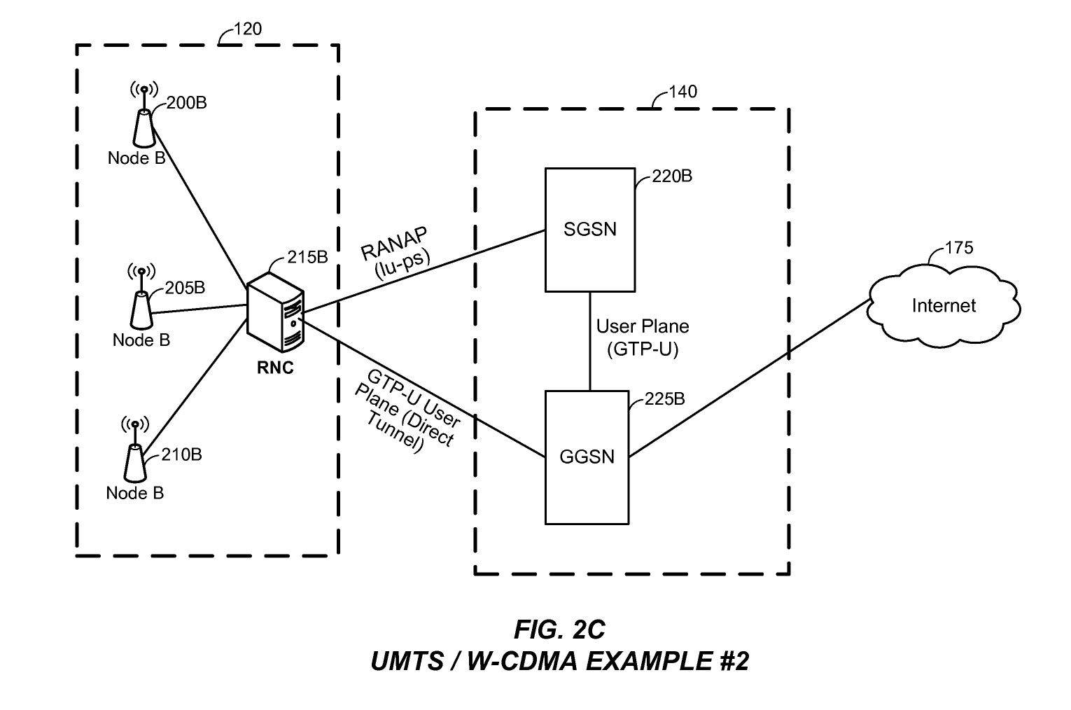

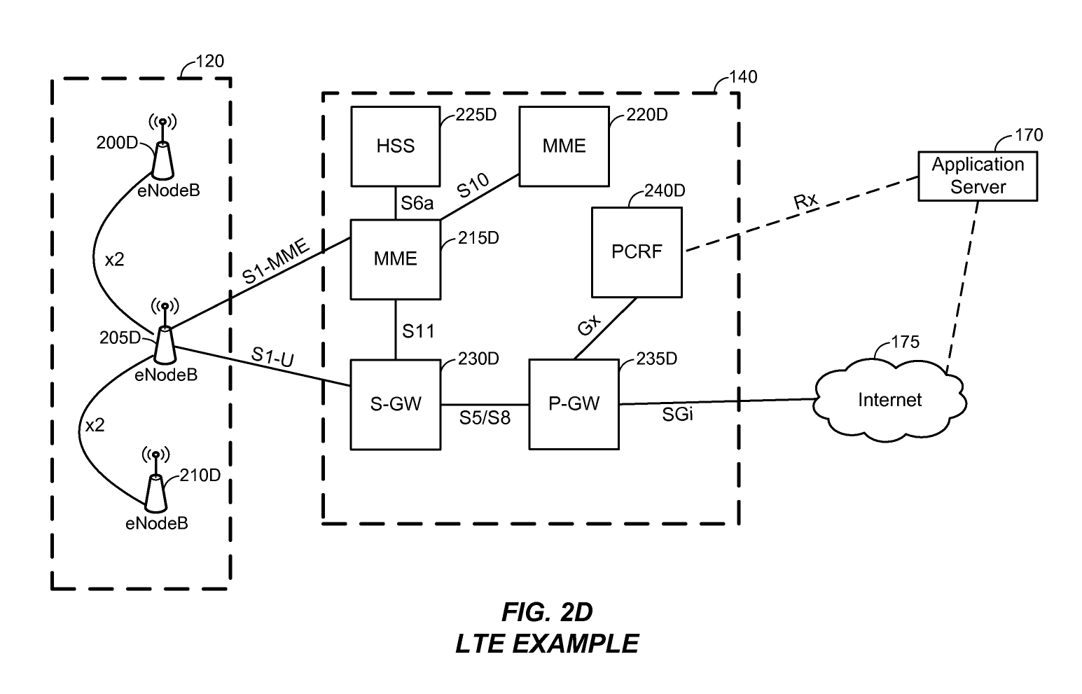

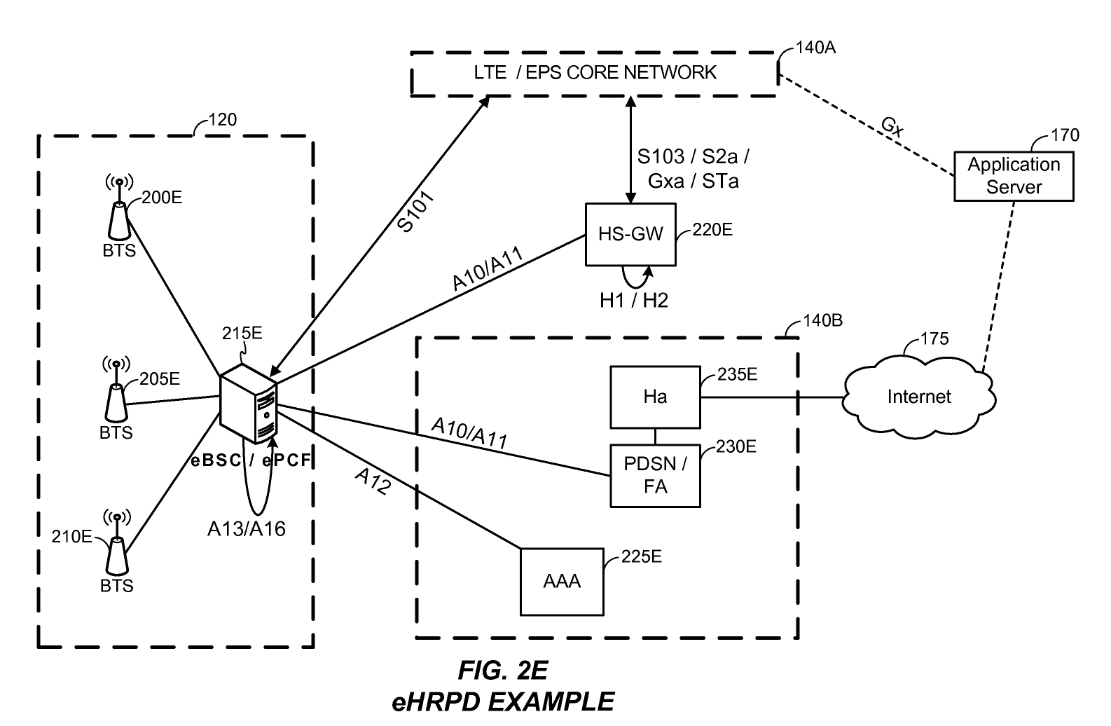

Examples of protocol-specific implementations for the RAN 120 and the core network 140 are provided below with respect to FIGS. 2A through 2D to help explain the wireless communications system 100 in more detail. In particular, the components of the RAN 120 and the core network 140 corresponds to components associated with supporting packet-switched (PS) communications, whereby legacy circuit-switched (CS) components may also be present in these networks, but any legacy CS-specific components are not shown explicitly in FIGS. 2A-2D.

FIG. 2A illustrates an example configuration of the RAN 120 and the core network 140 for packet-switched communications in a CDMA2000 1x Evolution-Data Optimized (EV-DO) network in accordance with an embodiment of the invention. Referring to FIG. 2A, the RAN 120 includes a plurality of base stations (BSs) 200A, 205A and 210A that are coupled to a base station controller (BSC) 215A over a wired backhaul interface. A group of BSs controlled by a single BSC is collectively referred to as a subnet. As will be appreciated by one of ordinary skill in the art, the RAN 120 can include multiple BSCs and subnets, and a single BSC is shown in FIG. 2A for the sake of convenience. The BSC 215A communicates with a packet control function (PCF) 220A within the core network 140 over an A9 connection. The PCF 220A performs certain processing functions for the BSC 215A related to packet data. The PCF 220A communicates with a Packet Data Serving Node (PDSN) 225A within the core network 140 over an A11 connection. The PDSN 225A has a variety of functions, including managing Point-to-Point (PPP) sessions, acting as a home agent (HA) and/or foreign agent (FA), and is similar in function to a Gateway General Packet Radio Service (GPRS) Support Node (GGSN) in GSM and UMTS networks (described below in more detail). The PDSN 225A connects the core network 140 to external IP networks, such as the Internet 175.

FIG. 2B illustrates an example configuration of the RAN 120 and a packet-switched portion of the core network 140 that is configured as a GPRS core network within a 3G UMTS W-CDMA system in accordance with an embodiment of the invention. Referring to FIG. 2B, the RAN 120 includes a plurality of Node Bs 200B, 205B and 210B that are coupled to a Radio Network Controller (RNC) 215B over a wired backhaul interface. Similar to 1×EV-DO networks, a group of Node Bs controlled by a single RNC is collectively referred to as a subnet. As will be appreciated by one of ordinary skill in the art, the RAN 120 can include multiple RNCs and subnets, and a single RNC is shown in FIG. 2B for the sake of convenience. The RNC 215B is responsible for signaling, establishing and tearing down bearer channels (i.e., data channels) between a Serving GRPS Support Node (SGSN) 220B in the core network 140 and UEs served by the RAN 120. If link layer encryption is enabled, the RNC 215B also encrypts the content before forwarding it to the RAN 120 for transmission over an air interface. The function of the RNC 215B is well-known in the art and will not be discussed further for the sake of brevity.

In FIG. 2B, the core network 140 includes the above-noted SGSN 220B (and potentially a number of other SGSNs as well) and a GGSN 225B. Generally, GPRS is a protocol used in GSM for routing IP packets. The GPRS core network (e.g., the GGSN 225B and one or more SGSNs 220B) is the centralized part of the GPRS system and also provides support for W-CDMA based 3G access networks. The GPRS core network is an integrated part of the GSM core network (i.e., the core network 140) that provides mobility management, session management and transport for IP packet services in GSM and W-CDMA networks.

The GPRS Tunneling Protocol (GTP) is the defining IP protocol of the GPRS core network. The GTP is the protocol which allows end users (e.g., UEs) of a GSM or W-CDMA network to move from place to place while continuing to connect to the Internet 175 as if from one location at the GGSN 225B. This is achieved by transferring the respective UE's data from the UE's current SGSN 220B to the GGSN 225B, which is handling the respective UE's session.

Three forms of GTP are used by the GPRS core network; namely, (i) GTP-U, (ii) GTP-C and (iii) GTP′ (GTP Prime). GTP-U is used for transfer of user data in separated tunnels for each packet data protocol (PDP) context. GTP-C is used for control signaling (e.g., setup and deletion of PDP contexts, verification of GSN reach-ability, updates or modifications such as when a subscriber moves from one SGSN to another, etc.). GTP′ is used for transfer of charging data from GSNs to a charging function.

Referring to FIG. 2B, the GGSN 225B acts as an interface between a GPRS backbone network (not shown) and the Internet 175. The GGSN 225B extracts packet data with associated a packet data protocol (PDP) format (e.g., IP or PPP) from GPRS packets coming from the SGSN 220B, and sends the packets out on a corresponding packet data network. In the other direction, the incoming data packets are directed by the GGSN connected UE to the SGSN 220B which manages and controls the Radio Access Bearer (RAB) of a target UE served by the RAN 120. Thereby, the GGSN 225B stores the current SGSN address of the target UE and its associated profile in a location register (e.g., within a PDP context). The GGSN 225B is responsible for IP address assignment and is the default router for a connected UE. The GGSN 225B also performs authentication and charging functions.

The SGSN 220B is representative of one of many SGSNs within the core network 140, in an example. Each SGSN is responsible for the delivery of data packets from and to the UEs within an associated geographical service area. The tasks of the SGSN 220B includes packet routing and transfer, mobility management (e.g., attach/detach and location management), logical link management, and authentication and charging functions. The location register of the SGSN 220B stores location information (e.g., current cell, current VLR) and user profiles (e.g., IMSI, PDP address(es) used in the packet data network) of all GPRS users registered with the SGSN 220B, for example, within one or more PDP contexts for each user or UE. Thus, SGSNs 220B are responsible for (i) de-tunneling downlink GTP packets from the GGSN 225B, (ii) uplink tunnel IP packets toward the GGSN 225B, (iii) carrying out mobility management as UEs move between SGSN service areas and (iv) billing mobile subscribers. As will be appreciated by one of ordinary skill in the art, aside from (i)-(iv), SGSNs configured for GSM/EDGE networks have slightly different functionality as compared to SGSNs configured for W-CDMA networks.

The RAN 120 (e.g., or UTRAN, in UMTS system architecture) communicates with the SGSN 220B via a Radio Access Network Application Part (RANAP) protocol. RANAP operates over a Iu interface (Iu-ps), with a transmission protocol such as Frame Relay or IP. The SGSN 220B communicates with the GGSN 225B via a Gn interface, which is an IP-based interface between SGSN 220B and other SGSNs (not shown) and internal GGSNs (not shown), and uses the GTP protocol defined above (e.g., GTP-U, GTP-C, GTP′, etc.). In the embodiment of FIG. 2B, the Gn between the SGSN 220B and the GGSN 225B carries both the GTP-C and the GTP-U. While not shown in FIG. 2B, the Gn interface is also used by the Domain Name System (DNS). The GGSN 225B is connected to a Public Data Network (PDN) (not shown), and in turn to the Internet 175, via a Gi interface with IP protocols either directly or through a Wireless Application Protocol (WAP) gateway.

FIG. 2C illustrates another example configuration of the RAN 120 and a packet-switched portion of the core network 140 that is configured as a GPRS core network within a 3G UMTS W-CDMA system in accordance with an embodiment of the invention. Similar to FIG. 2B, the core network 140 includes the SGSN 220B and the GGSN 225B. However, in FIG. 2C, Direct Tunnel is an optional function in Iu mode that allows the SGSN 220B to establish a direct user plane tunnel, GTP-U, between the RAN 120 and the GGSN 225B within a PS domain. A Direct Tunnel capable SGSN, such as SGSN 220B in FIG. 2C, can be configured on a per GGSN and per RNC basis whether or not the SGSN 220B can use a direct user plane connection. The SGSN 220B in FIG. 2C handles the control plane signaling and makes the decision of when to establish Direct Tunnel. When the RAB assigned for a PDP context is released (i.e. the PDP context is preserved) the GTP-U tunnel is established between the GGSN 225B and SGSN 220B in order to be able to handle the downlink packets.

FIG. 2D illustrates an example configuration of the RAN 120 and a packet-switched portion of the core network 140 based on an Evolved Packet System (EPS) or LTE network, in accordance with an embodiment of the invention. Referring to FIG. 2D, unlike the RAN 120 shown in FIGS. 2B-2C, the RAN 120 in the EPS/LTE network is configured with a plurality of Evolved Node Bs (ENodeBs or eNBs) 200D, 205D and 210D, without the RNC 215B from FIGS. 2B-2C. This is because ENodeBs in EPS/LTE networks do not require a separate controller (i.e., the RNC 215B) within the RAN 120 to communicate with the core network 140. In other words, some of the functionality of the RNC 215B from FIGS. 2B-2C is built into each respective eNodeB of the RAN 120 in FIG. 2D.

In FIG. 2D, the core network 140 includes a plurality of Mobility Management Entities (MMES) 215D and 220D, a Home Subscriber Server (HSS) 225D, a Serving Gateway (S-GW) 230D, a Packet Data Network Gateway (P-GW) 235D and a Policy and Charging Rules Function (PCRF) 240D. Network interfaces between these components, the RAN 120 and the Internet 175 are illustrated in FIG. 2D and are defined in Table 1 (below) as follows:

TABLE 1
EPS/LTE Core Network Connection Definitions

| Network | |
|---|---|
| Interface | Description |
| S1-MME | Reference point for the control plane protocol between |
| | RAN 120 and MME 215D. |
| S1-U | Reference point between RAN 120 and S-GW 230D for the |
| | per bearer user plane tunneling and inter-eNodeB path |
| | switching during handover. |
| S5 | Provides user plane tunneling and tunnel management |
| | between S-GW 230D and P-GW 235D. It is used for S-GW |
| | relocation due to UE mobility and if the S-GW 230D needs to |
| | connect to a non-collocated P-GW for the required PDN |
| | connectivity. |
| S6a | Enables transfer of subscription and authentication data for |
| | authenticating/authorizing user access to the evolved system |
| | (Authentication, Authorization, and Accounting [AAA] |
| | interface) between MME 215D and HSS 225D. |
| Gx | Provides transfer of Quality of Service (QoS) policy and |
| | charging rules from PCRF 240D to Policy a Charging |
| | Enforcement Function (PCEF) component (not shown) in the |
| | P-GW 235D. |
| S8 | Inter-PLMN reference point providing user and control plane |
| | between the S-GW 230D in a Visited Public Land Mobile |
| | Network (VPLMN) and the P-GW 235D in a Home Public |
| | Land Mobile Network (HPLMN). S8 is the inter-PLMN |
| | variant of S5. |
| S10 | Reference point between MMEs 215D and 220D for MME |
| | relocation and MME to MME information transfer. |
| S11 | Reference point between MME 215D and S-GW 230D. |
| SGi | Reference point between the P-GW 235D and the packet data |
| | network, shown in FIG. 2D as the Internet 175. The Packet |
| | data network may be an operator external public or private |
| | packet data network or an intra-operator packet data network |
| | (e.g., for provision of IMS services). This reference point |
| | corresponds to Gi for 3GPP accesses. |
| X2 | Reference point between two different eNodeBs used for UE |
| | handoffs. |
| Rx | Reference point between the PCRF 240D and an application |
| | function (AF) that is used to exchanged application-level |
| | session information, where the AF is represented in FIG. 1 by |
| | the application server 170. |

A high-level description of the components shown in the RAN 120 and core network 140 of FIG. 2D will now be described. However, these components are each well-known in the art from various 3GPP TS standards, and the description contained herein is not intended to be an exhaustive description of all functionalities performed by these components.

Referring to FIG. 2D, the MMEs 215D and 220D are configured to manage the control plane signaling for the EPS bearers. MME functions include: Non-Access Stratum (NAS) signaling, NAS signaling security, Mobility management for inter- and intra-technology handovers, P-GW and S-GW selection, and MME selection for handovers with MME change.

Referring to FIG. 2D, the S-GW 230D is the gateway that terminates the interface toward the RAN 120. For each UE associated with the core network 140 for an EPS-based system, at a given point of time, there is a single S-GW. The functions of the S-GW 230D, for both the GTP-based and the Proxy Mobile IPv6 (PMIP)-based S5/S8, include: Mobility anchor point, Packet routing and forwarding, and setting the DiffSery Code Point (DSCP) based on a QoS Class Identifier (QCI) of the associated EPS bearer.

Referring to FIG. 2D, the P-GW 235D is the gateway that terminates the SGi interface toward the Packet Data Network (PDN), e.g., the Internet 175. If a UE is accessing multiple PDNs, there may be more than one P-GW for that UE; however, a mix of S5/S8 connectivity and Gn/Gp connectivity is not typically supported for that UE simultaneously. P-GW functions include for both the GTP-based S5/S8: Packet filtering (by deep packet inspection), UE IP address allocation, setting the DSCP based on the QCI of the associated EPS bearer, accounting for inter operator charging, uplink (UL) and downlink (DL) bearer binding as defined in 3GPP TS 23.203, UL bearer binding verification as defined in 3GPP TS 23.203. The P-GW 235D provides PDN connectivity to both GSM/EDGE Radio Access Network (GERAN)/UTRAN only UEs and E-UTRAN-capable UEs using any of E-UTRAN, GERAN, or UTRAN. The P-GW 235D provides PDN connectivity to E-UTRAN capable UEs using E-UTRAN only over the S5/S8 interface.

Referring to FIG. 2D, the PCRF 240D is the policy and charging control element of the EPS-based core network 140. In a non-roaming scenario, there is a single PCRF in the HPLMN associated with a UE's Internet Protocol Connectivity Access Network (IP-CAN) session. The PCRF terminates the Rx interface and the Gx interface. In a roaming scenario with local breakout of traffic, there may be two PCRFs associated with a UE's IP-CAN session: A Home PCRF (H-PCRF) is a PCRF that resides within a HPLMN, and a Visited PCRF (V-PCRF) is a PCRF that resides within a visited VPLMN. PCRF is described in more detail in 3GPP TS 23.203, and as such will not be described further for the sake of brevity. In FIG. 2D, the application server 170 (e.g., which can be referred to as the AF in 3GPP terminology) is shown as connected to the core network 140 via the Internet 175, or alternatively to the PCRF 240D directly via an Rx interface. Generally, the application server 170 (or AF) is an element offering applications that use IP bearer resources with the core network (e.g. UMTS PS domain/GPRS domain resources/LTE PS data services). One example of an application function is the Proxy-Call Session Control Function (P-CSCF) of the IP Multimedia Subsystem (IMS) Core Network sub system. The AF uses the Rx reference point to provide session information to the PCRF 240D. Any other application server offering IP data services over cellular network can also be connected to the PCRF 240D via the Rx reference point.

FIG. 2E illustrates an example of the RAN 120 configured as an enhanced High Rate Packet Data (HRPD) RAN connected to an EPS or LTE network 140A and also a packet-switched portion of an HRPD core network 140B in accordance with an embodiment of the invention. The core network 140A is an EPS or LTE core network, similar to the core network described above with respect to FIG. 2D.

In FIG. 2E, the eHRPD RAN includes a plurality of base transceiver stations (BTSs) 200E, 205E and 210E, which are connected to an enhanced BSC (eBSC) and enhanced PCF (ePCF) 215E. The eBSC/ePCF 215E can connect to one of the MMEs 215D or 220D within the EPS core network 140A over an 5101 interface, and to an HRPD serving gateway (HSGW) 220E over A10 and/or A11 interfaces for interfacing with other entities in the EPS core network 140A (e.g., the S-GW 220D over an 5103 interface, the P-GW 235D over an S2a interface, the PCRF 240D over a Gxa interface, a 3GPP AAA server (not shown explicitly in FIG. 2D) over an STa interface, etc.). The HSGW 220E is defined in 3GPP2 to provide the interworking between HRPD networks and EPS/LTE networks. As will be appreciated, the eHRPD RAN and the HSGW 220E are configured with interface functionality to EPC/LTE networks that is not available in legacy HRPD networks.

Turning back to the eHRPD RAN, in addition to interfacing with the EPS/LTE network 140A, the eHRPD RAN can also interface with legacy HRPD networks such as HRPD network 140B. As will be appreciated the HRPD network 140B is an example implementation of a legacy HRPD network, such as the EV-DO network from FIG. 2A. For example, the eBSC/ePCF 215E can interface with an authentication, authorization and accounting (AAA) server 225E via an A12 interface, or to a PDSN/FA 230E via an A10 or A11 interface. The PDSN/FA 230E in turn connects to HA 235A, through which the Internet 175 can be accessed. In FIG. 2E, certain interfaces (e.g., A13, A16, H1, H2, etc.) are not described explicitly but are shown for completeness and would be understood by one of ordinary skill in the art familiar with HRPD or eHRPD.

Referring to FIGS. 2B-2E, it will be appreciated that LTE core networks (e.g., FIG. 2D) and HRPD core networks that interface with eHRPD RANs and HSGWs (e.g., FIG. 2E) can support network-initiated Quality of Service (QoS) (e.g., by the P-GW, GGSN, SGSN, etc.) in certain cases.

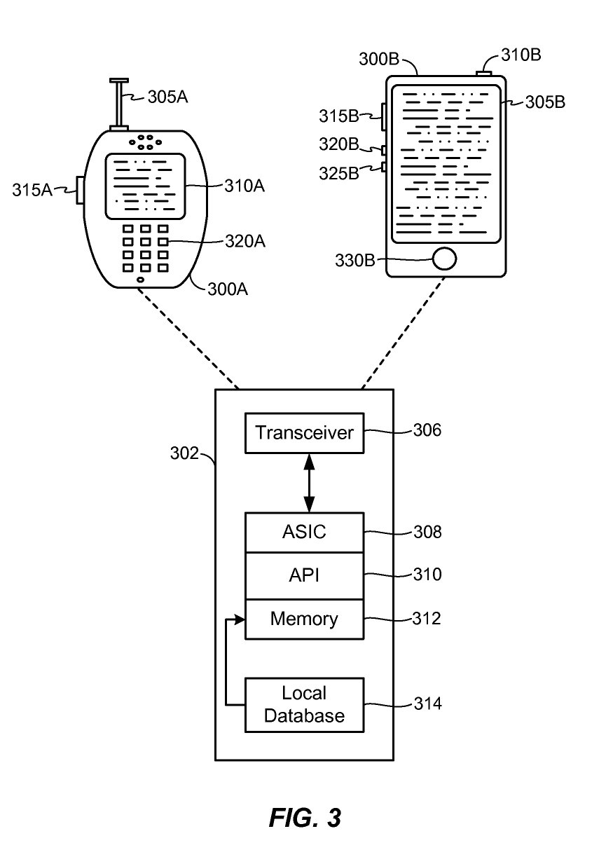

FIG. 3 illustrates examples of UEs in accordance with embodiments of the invention. Referring to FIG. 3, UE 300A is illustrated as a calling telephone and UE 300B is illustrated as a touchscreen device (e.g., a smart phone, a tablet computer, etc.). As shown in FIG. 3, an external casing of UE 300A is configured with an antenna 305A, display 310A, at least one button 315A (e.g., a PTT button, a power button, a volume control button, etc.) and a keypad 320A among other components, as is known in the art. Also, an external casing of UE 300B is configured with a touchscreen display 305B, peripheral buttons 310B, 315B, 320B and 325B (e.g., a power control button, a volume or vibrate control button, an airplane mode toggle button, etc.), at least one front-panel button 330B (e.g., a Home button, etc.), among other components, as is known in the art. While not shown explicitly as part of UE 300B, the UE 300B can include one or more external antennas and/or one or more integrated antennas that are built into the external casing of UE 300B, including but not limited to WiFi antennas, cellular antennas, satellite position system (SPS) antennas (e.g., global positioning system (GPS) antennas), and so on.

While internal components of UEs such as the UEs 300A and 300B can be embodied with different hardware configurations, a basic high-level UE configuration for internal hardware components is shown as platform 302 in FIG. 3. The platform 302 can receive and execute software applications, data and/or commands transmitted from the RAN 120 that may ultimately come from the core network 140, the Internet 175 and/or other remote servers and networks (e.g., application server 170, web URLs, etc.). The platform 302 can also independently execute locally stored applications without RAN interaction. The platform 302 can include a transceiver 306 operably coupled to an application specific integrated circuit (ASIC) 308, or other processor, microprocessor, logic circuit, or other data processing device. The ASIC 308 or other processor executes the application programming interface (API) 310 layer that interfaces with any resident programs in the memory 312 of the wireless device. The memory 312 can be comprised of read-only or random-access memory (RAM and ROM), EEPROM, flash cards, or any memory common to computer platforms. The platform 302 also can include a local database 314 that can store applications not actively used in memory 312, as well as other data. The local database 314 is typically a flash memory cell, but can be any secondary storage device as known in the art, such as magnetic media, EEPROM, optical media, tape, soft or hard disk, or the like.

Accordingly, an embodiment of the invention can include a UE (e.g., UE 300A, 300B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 308, memory 312, API 310 and local database 314 may all be used cooperatively to load, store and execute the various functions disclosed herein and thus the logic to perform these functions may be distributed over various elements. Alternatively, the functionality could be incorporated into one discrete component. Therefore, the features of the UEs 300A and 300B in FIG. 3 are to be considered merely illustrative and the invention is not limited to the illustrated features or arrangement.

The wireless communication between the UEs 300A and/or 300B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

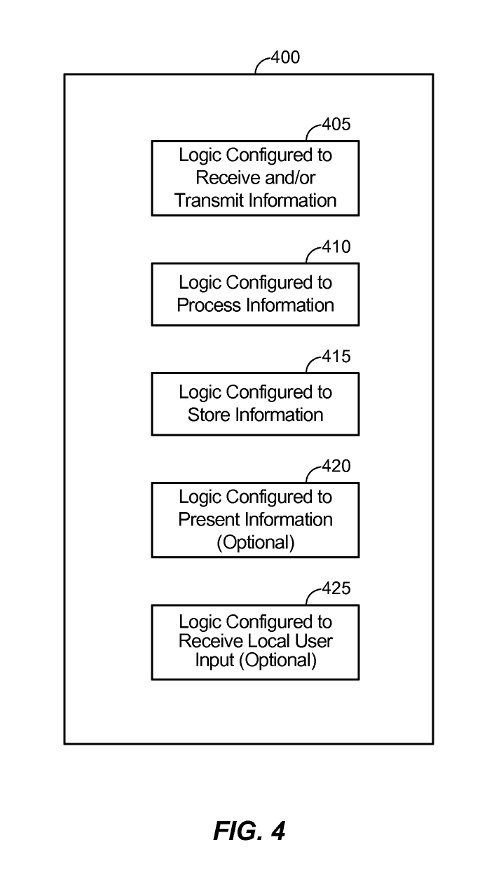

FIG. 4 illustrates a communication device 400 that includes logic configured to perform functionality. The communication device 400 can correspond to any of the above-noted communication devices, including but not limited to UEs 300A or 300B, any component of the RAN 120 (e.g., BSs 200A through 210A, BSC 215A, Node Bs 200B through 210B, RNC 215B, eNodeBs 200D through 210D, etc.), any component of the core network 140 (e.g., PCF 220A, PDSN 225A, SGSN 220B, GGSN 225B, MME 215D or 220D, HSS 225D, S-GW 230D, P-GW 235D, PCRF 240D), any components coupled with the core network 140 and/or the Internet 175 (e.g., the application server 170), and so on. Thus, communication device 400 can correspond to any electronic device that is configured to communicate with (or facilitate communication with) one or more other entities over the wireless communications system 100 of FIG. 1.

Referring to FIG. 4, the communication device 400 includes logic configured to receive and/or transmit information 405. In an example, if the communication device 400 corresponds to a wireless communications device (e.g., UE 300A or 300B, one of BSs 200A through 210A, one of Node Bs 200B through 210B, one of eNodeBs 200D through 210D, etc.), the logic configured to receive and/or transmit information 405 can include a wireless communications interface (e.g., Bluetooth, WiFi, 2G, CDMA, W-CDMA, 3G, 4G, LTE, etc.) such as a wireless transceiver and associated hardware (e.g., an RF antenna, a MODEM, a modulator and/or demodulator, etc.). In another example, the logic configured to receive and/or transmit information 405 can correspond to a wired communications interface (e.g., a serial connection, a USB or Firewire connection, an Ethernet connection through which the Internet 175 can be accessed, etc.). Thus, if the communication device 400 corresponds to some type of network-based server (e.g., PDSN, SGSN, GGSN, S-GW, P-GW, MME, HSS, PCRF, the application 170, etc.), the logic configured to receive and/or transmit information 405 can correspond to an Ethernet card, in an example, that connects the network-based server to other communication entities via an Ethernet protocol. In a further example, the logic configured to receive and/or transmit information 405 can include sensory or measurement hardware by which the communication device 400 can monitor its local environment (e.g., an accelerometer, a temperature sensor, a light sensor, an antenna for monitoring local RF signals, etc.). The logic configured to receive and/or transmit information 405 can also include software that, when executed, permits the associated hardware of the logic configured to receive and/or transmit information 405 to perform its reception and/or transmission function(s). However, the logic configured to receive and/or transmit information 405 does not correspond to software alone, and the logic configured to receive and/or transmit information 405 relies at least in part upon hardware to achieve its functionality.

Referring to FIG. 4, the communication device 400 further includes logic configured to process information 410. In an example, the logic configured to process information 410 can include at least a processor. Example implementations of the type of processing that can be performed by the logic configured to process information 410 includes but is not limited to performing determinations, establishing connections, making selections between different information options, performing evaluations related to data, interacting with sensors coupled to the communication device 400 to perform measurement operations, converting information from one format to another (e.g., between different protocols such as .wmv to .avi, etc.), and so on. For example, the processor included in the logic configured to process information 410 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 410 can also include software that, when executed, permits the associated hardware of the logic configured to process information 410 to perform its processing function(s). However, the logic configured to process information 410 does not correspond to software alone, and the logic configured to process information 410 relies at least in part upon hardware to achieve its functionality.

Referring to FIG. 4, the communication device 400 further includes logic configured to store information 415. In an example, the logic configured to store information 415 can include at least a non-transitory memory and associated hardware (e.g., a memory controller, etc.). For example, the non-transitory memory included in the logic configured to store information 415 can correspond to RAM memory, flash memory, ROM memory, EPROM memory, EEPROM memory, registers, hard disk, a removable disk, a CD-ROM, or any other form of storage medium known in the art. The logic configured to store information 415 can also include software that, when executed, permits the associated hardware of the logic configured to store information 415 to perform its storage function(s). However, the logic configured to store information 415 does not correspond to software alone, and the logic configured to store information 415 relies at least in part upon hardware to achieve its functionality.

Referring to FIG. 4, the communication device 400 further optionally includes logic configured to present information 420. In an example, the logic configured to present information 420 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 400. For example, if the communication device 400 corresponds to UE 300A or UE 300B as shown in FIG. 3, the logic configured to present information 420 can include the display 310A of UE 300A or the touchscreen display 305B of UE 300B. In a further example, the logic configured to present information 420 can be omitted for certain communication devices, such as network communication devices that do not have a local user (e.g., network switches or routers, remote servers, etc.). The logic configured to present information 420 can also include software that, when executed, permits the associated hardware of the logic configured to present information 420 to perform its presentation function(s). However, the logic configured to present information 420 does not correspond to software alone, and the logic configured to present information 420 relies at least in part upon hardware to achieve its functionality.

Referring to FIG. 4, the communication device 400 further optionally includes logic configured to receive local user input 425. In an example, the logic configured to receive local user input 425 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 400. For example, if the communication device 400 corresponds to UE 300A or UE 300B as shown in FIG. 3, the logic configured to receive local user input 425 can include the keypad 320A, any of the buttons 315A or 310B through 325B, the touchscreen display 305B, etc. In a further example, the logic configured to receive local user input 425 can be omitted for certain communication devices, such as network communication devices that do not have a local user (e.g., network switches or routers, remote servers, etc.). The logic configured to receive local user input 425 can also include software that, when executed, permits the associated hardware of the logic configured to receive local user input 425 to perform its input reception function(s). However, the logic configured to receive local user input 425 does not correspond to software alone, and the logic configured to receive local user input 425 relies at least in part upon hardware to achieve its functionality.

Referring to FIG. 4, while the configured logics of 405 through 425 are shown as separate or distinct blocks in FIG. 4, it will be appreciated that the hardware and/or software by which the respective configured logic performs its functionality can overlap in part. For example, any software used to facilitate the functionality of the configured logics of 405 through 425 can be stored in the non-transitory memory associated with the logic configured to store information 415, such that the configured logics of 405 through 425 each performs their functionality (i.e., in this case, software execution) based in part upon the operation of software stored by the logic configured to store information 415. Likewise, hardware that is directly associated with one of the configured logics can be borrowed or used by other configured logics from time to time. For example, the processor of the logic configured to process information 410 can format data into an appropriate format before being transmitted by the logic configured to receive and/or transmit information 405, such that the logic configured to receive and/or transmit information 405 performs its functionality (i.e., in this case, transmission of data) based in part upon the operation of hardware (i.e., the processor) associated with the logic configured to process information 410.

Generally, unless stated otherwise explicitly, the phrase “logic configured to” as used throughout this disclosure is intended to invoke an embodiment that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

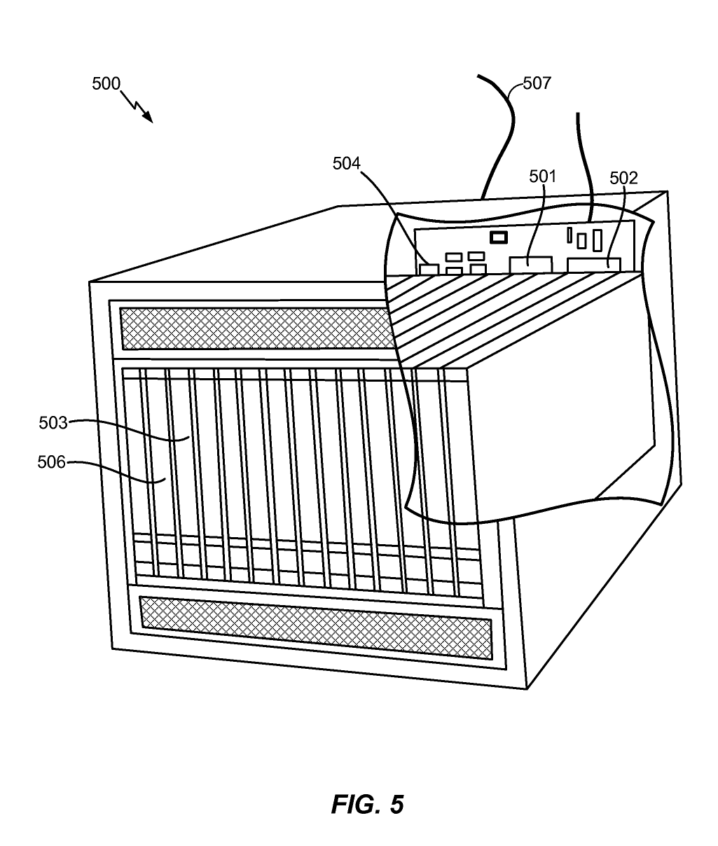

The various embodiments may be implemented on any of a variety of commercially available server devices, such as server 500 illustrated in FIG. 5. In an example, the server 500 may correspond to one example configuration of the application server 170 described above. In FIG. 5, the server 500 includes a processor 500 coupled to volatile memory 502 and a large capacity nonvolatile memory, such as a disk drive 503. The server 500 may also include a floppy disc drive, compact disc (CD) or DVD disc drive 506 coupled to the processor 501. The server 500 may also include network access ports 504 coupled to the processor 501 for establishing data connections with a network 507, such as a local area network coupled to other broadcast system computers and servers or to the Internet. In context with FIG. 4, it will be appreciated that the server 500 of FIG. 5 illustrates one example implementation of the communication device 400, whereby the logic configured to transmit and/or receive information 405 corresponds to the network access ports 504 used by the server 500 to communicate with the network 507, the logic configured to process information 410 corresponds to the processor 501, and the logic configuration to store information 415 corresponds to any combination of the volatile memory 502, the disk drive 503 and/or the disc drive 506. The optional logic configured to present information 420 and the optional logic configured to receive local user input 425 are not shown explicitly in FIG. 5 and may or may not be included therein. Thus, FIG. 5 helps to demonstrate that the communication device 400 may be implemented as a server, in addition to a UE implementation as in 305A or 305B as in FIG. 3.

Access networks using various communication protocols (e.g., 3GPP access networks such as W-CDMA, LTE, etc. as described above with respect to FIGS. 2A-2E, or non-3GPP access networks such as WiFi, WLAN or wired LAN, IEEE 802, IEEE 802.11, etc.) can be configured to provide Internet Protocol (IP) Multimedia Subsystem (IMS) services via an IMS network managed by an operator (e.g., Verizon, Sprint, AT&T, etc.) to users across a communications system. Users that access the IMS network to request an IMS service are assigned to one of a plurality of regional application servers or application server clusters (e.g., groups of application servers that serve the same cluster region) for supporting the requested IMS service. However, a user accessing the IMS network over a non-3GPP access network (e.g., WiFi) can cause the user to be served by an application server that is not proximate to the user's location due in part to difficulties in identifying users connected to non-3GPP access networks. Thus, two users accessing the same IMS network, requesting the same IMS service (e.g., VoIP, PTT, etc.) and are physically co-located may actually be served via different deployment clusters of the application servers. Assigning application servers to users in this manner can increase the complexity of providing the IMS services in terms of pre-processing (e.g., call setup, user lookup, etc.) and post-processing (e.g., billing, CALEA, etc.). Additionally, assigning a non-physically co-located application server to a user increases the backend traffic between the cluster regions as well.

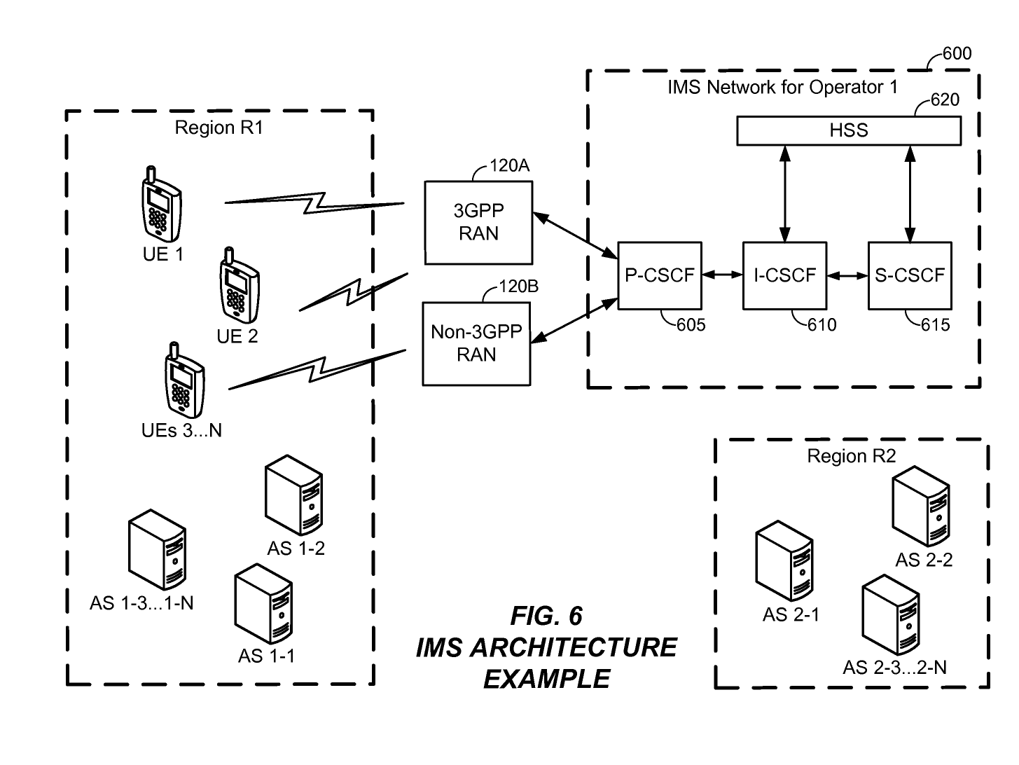

FIG. 6 illustrates an example of IMS architecture in accordance with an embodiment of the invention. Referring to FIG. 6, assume that a first cluster of application servers denoted as AS 1-1, AS 1-2 . . . AS 1-N is configured to provide IMS service to UEs and is located (or deployed) in a first region, and that a second cluster of application servers denoted as AS 2-1, AS 2-2 . . . AS 2-N is configured to provide IMS service to UEs is located (or deployed) in a second region. While not shown in FIG. 6 explicitly, other clusters of application servers can be deployed in other cluster regions as well. In FIG. 6, each cluster of application servers is assumed to be operated by the same operator (e.g., Sprint, Verizon, AT&T, etc.). In FIG. 6, UEs 1 . . . N are assumed to be operating in cluster region R1 and are configured to connect either to a 3GPP RAN 120A (e.g., any of RANs 120 from FIGS. 2A-2E) or a non-3GPP RAN 120B (e.g., a wired Ethernet connection, a WiFi connection such as AP 125, etc.). UEs 1 . . . N can then connect to an IMS network 600 through either the 3GPP RAN 120A or the non-3GPP RAN 120B.

Referring to FIG. 6, the IMS network 600 is shown as illustrating a particular set of IMS components, including a proxy call session control function (P-CSCF) 605, an interrogating CSCF (I-CSCF) 610, a serving CSCF (S-CSCF) 615 and a Home Subscriber Server (HSS) 620. The P-CSCF 605, I-CSCF 610 and S-CSCF 615 are sometimes referred to collectively as the CSCF, and the CSCF is responsible for signaling via Session Initiation Protocol (SIP) between the Transport Plane, Control Plane, and the Application Plane of the IMS network 600.

Referring to the P-CSCF 605 of FIG. 6, the P-CSCF 605 is responsible for interfacing directly with Transport Plane components and is the first point of signaling within the IMS network 600 for any end-point, such as UEs 1 . . . N. Once an endpoint acquires IP connectivity, the end point will cause a registration event to occur by first signaling to the P-CSCF 605. As the name implies, the P-CSCF 605 is a proxy for SIP messages from end-points to the rest of the IMS network 600. It is usually in a home network of the end point, but may reside in a visited network of the end point. The P-CSCF 605 will use a DNS look-up to identify a target I-CSCF 610 to send SIP messages, which could be an I-CSCF 610 in its own network or another I-CSCF across an administrative domain. The P-CSCF 605 can also be responsible for policy decisions (e.g., via an integrated or standalone Policy Decision Function (PDF) in Releases 5 or 6 of IMS, via a Policy Charging, and Resource Function (PCRF) in Release 7 of IMS, etc.).

Referring to the I-CSCF 610 of FIG. 6, the main function of the I-CSCF 610 is to proxy between the P-CSCF 605 as entry point and S-CSCF 615 as control point for applications found in the Applications Plane. When the P-CSCF 605 receives a registration request SIP message, it will perform a DNS look-up to discover the appropriate I-CSCF 610 to route the message. Once the I-CSCF 610 receives the SIP message, it will perform a look-up operation with the HSS 620 via Diameter to determine the S-CSCF 615 that is associated with the end-point terminal Once it receives this information, it will forward the SIP message to the appropriate S-CSCF 610 for further treatment.

Referring to the S-CSCF 615, the S-CSCF 615 is responsible for interfacing with the Application Servers (AS) (e.g., such as application servers 1-1, 1-2 . . . 1-N in cluster region R1, or application servers 2-1, 2-2 . . . 2-N in cluster region 2, and so on) in the Application Plane. Upon receiving a registration request SIP message from an I-CSCF 610, the S-CSCF 615 will query the HSS 622 via Diameter protocol to register the terminal as being currently served by itself Subsequent session establishment requires knowing which S-CSCF 615 is responsible for the terminal session control. As part of the registration process, the S-CSCF 615 uses credentials it obtains from the query to the HSS 620 to issue an SIP message “challenge” back to the initiating P-CSCF 605 to authenticate the terminal.

In addition to acting as a registrar, the S-CSCF 615 is also responsible for routing SIP messages to the AS allowing for the Control Plane session control to interact with the Application Plane application logic. To do this, the S-CSCF 615 uses information obtained from the HSS 620 in the form of Initial Filter Criteria (IFC) that acts as triggers against inbound session establishment requests. The IFC includes rules that define how and where SIP messages should be routed to the various application servers that may reside in the Application Plane. The S-CSCF 615 may also act on Secondary Filter Criteria (SFC) obtained from the application servers during the course of messaging with them.

Referring to FIG. 6, a UE that requests IMS service (e.g., registration to set-up or join a VoIP session, a PTT session, a group communication session, etc.) from the IMS network 600 is assigned (or registered) to a target application server that is selected by the S-CSCF 615, as noted above. Generally, the IMS network 600 will attempt to select, as the target application server, an application server that is physically close to the UE and is also known to be capable of providing the requested IMS service. However, the S-CSCF 615 may not be able to determine the locations of UEs connected to the non-3GPP RAN 120B, which can make it difficult to select a proximate application server to assign to the non-3GPP UEs. Also, even if the S-CSCF 615 is able to ascertain the location of a UE requesting IMS service, using the UE's location to independently select the application server to be assigned to the UE may result in sub-optimal performance for group communication sessions.

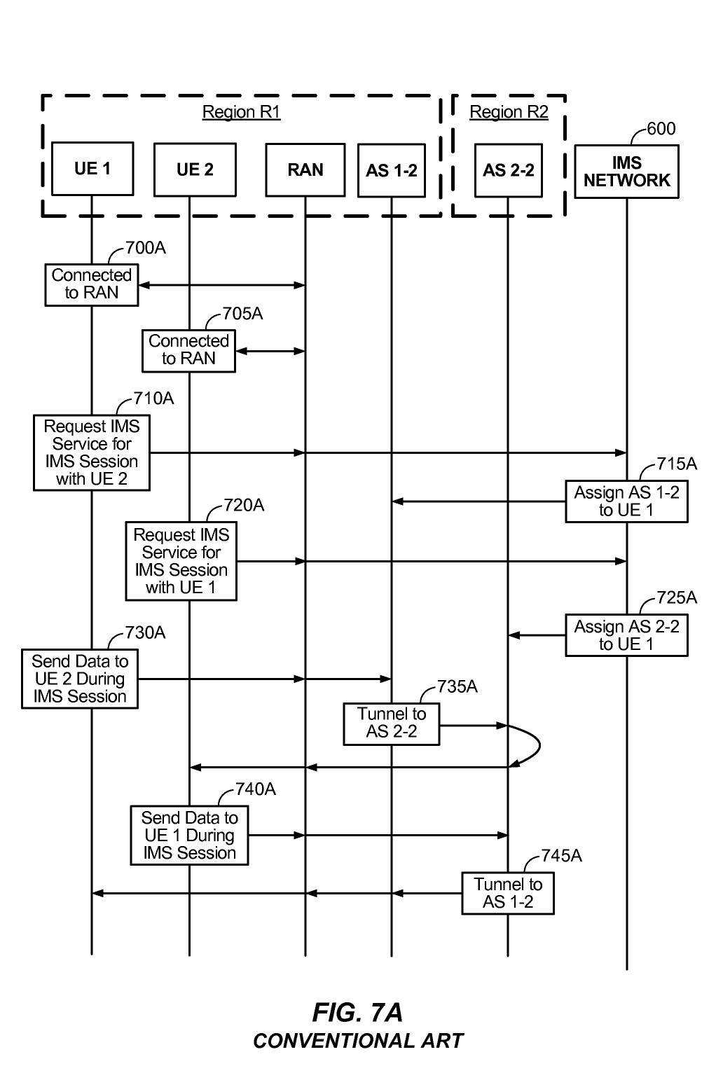

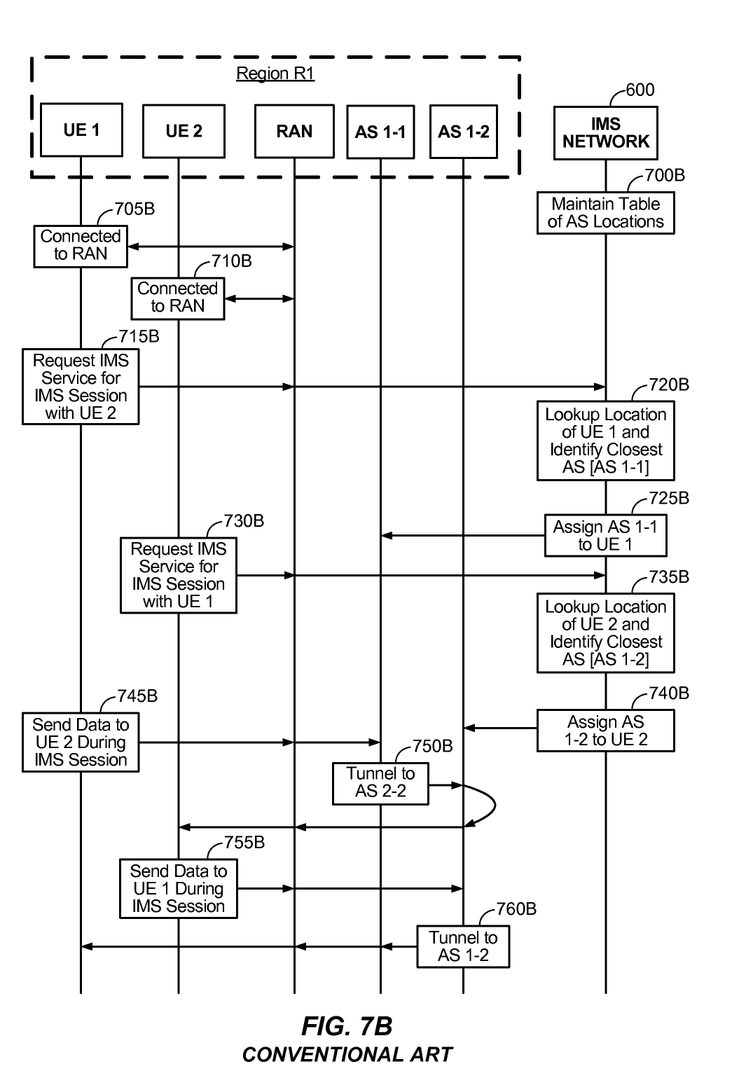

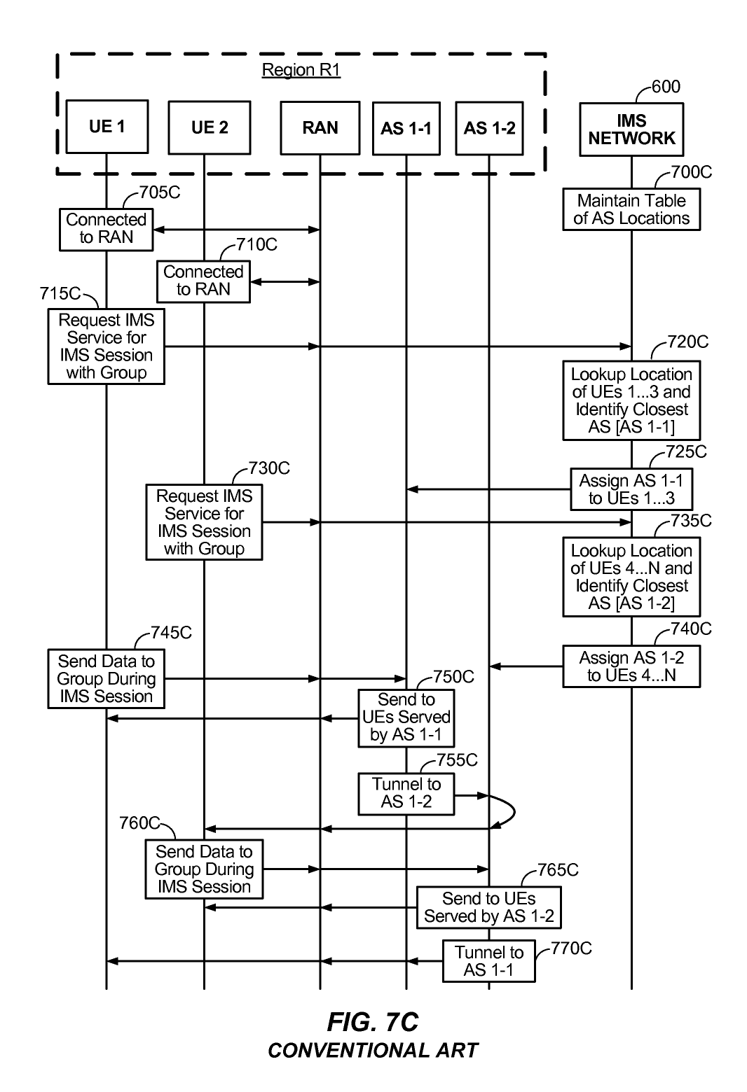

FIG. 7A illustrates a conventional process of setting up an IMS session between UEs 1 and 2. Referring to FIG. 7A, UE 1 and UE 2 are both connected to RANs, which may each correspond to either the 3GPP RAN 120A or the non-3GPP RAN 120B from FIG. 6, 700A-705A. While connected to its respective RAN, UE 1 transmits a request for IMS service in order to set-up or join an IMS session between UE 1 and UE 2, 710A. The IMS network 600 receives the IMS service request from UE 1 and assigns AS 1-2 in cluster region R1 to UE 1 for supporting the IMS session, 715A. The IMS network 600 selects AS 1-2 based upon the location of UE 1 (if known) whereby AS 1-2 is the closest application server to UE 1 in terms of geographic location and/or propagation speed. Alternatively, if the IMS network 600 is unaware of the location of UE 1 (e.g., if UE 1 is non-3GPP connected), AS 1-2 may simply be selected for assignment to UE 1 in a random manner (e.g., based on which application server has the lowest load, etc.).

While connected to its respective RAN, UE 2 also transmits a request for IMS service in order to join the IMS session between UE 1 and UE 2, 720A. The IMS network 600 receives the IMS service request from UE 2 and assigns AS 2-2 in cluster region R2 to UE 2 for supporting the IMS session, 725A. As will be appreciated, AS 2-2 is not in the same cluster region as UEs 1 or 2, but the IMS network 600 can select the remotely located AS 2-2 if the IMS network 600 is unaware of the location of UE 2, such as when UE 2 is connected to the non-3GPP RAN 120B.

Based on the above-noted application server assignments for the IMS session, when UE 1 sends data to UE 2 during the IMS session at 730A, AS 1-2 tunnels the data via a backhaul connection to AS 2-2, 735A, which adds to propagation delays and network resource consumption. Also, when UE 2 sends data to UE 1 during the IMS session at 740A, AS 2-2 tunnels the data via a backhaul connection to AS 1-2, 745A, which similarly adds to propagation delays and network resource consumption.

FIG. 7B illustrates another conventional process of setting up IMS service between UEs 1 and 2 where the assignment of application servers is based on location. Referring to FIG. 7B, the IMS network 600 maintains a table of locations for the application servers that are available to the operator for assigning to UEs for supporting IMS service on behalf of that operator, 700B.

In FIG. 7B, UE 1 and UE 2 are both connected to the 3GPP RAN 120A, 705B-710B. While connected to the 3GPP RAN 120A, UE 1 transmits a request for IMS service in order to set-up or join an IMS session between UE 1 and UE 2, 715B. The IMS network 600 receives the IMS service request from UE 1, looks up the location of UE 1 (e.g., retrievable from a presence server which tracks locations for 3GPP-connected UEs) and identifies a closest application server to be assigned to UE 1 based on a comparison between UE l's location and the table from 700B, 720B. In this case, assume that the IMS network 600 identifies AS 1-1 as the closest application server to UE 1 at 720B, and the IMS network 600 assigns AS 1-1 to UE 1 at 725B.

While connected to the 3GPP RAN 120A, UE 2 transmits a request for IMS service in order to join the IMS session between UE 1 and UE 2, 730B. The IMS network 600 receives the IMS service request from UE 2, looks up the location of UE 2 (e.g., retrievable from the above-noted presence server) and identifies a closest application server to be assigned to UE 2 based on a comparison between UE 2's location and the table from 700B, 735B. In this case, assume that the IMS network 600 identifies AS 1-2 as the closest application server to UE 2 at 735B, and the IMS network 600 assigns AS 1-2 to UE 1 at 740B.

Based on the above-noted application server assignments for the IMS session, when UE 1 sends data to UE 2 during the IMS session at 745B, AS 1-2 tunnels the data via a backhaul connection to AS 1-1, 750B. Also, when UE 2 sends data to UE 1 during the IMS session at 755B, AS 2-2 tunnels the data via a backhaul connection to AS 1-2, 760B. While the intra-region tunneling at 750B and 760B likely introduces less delays as compared to the inter-region tunneling of 735A and 745A of FIG. 7A, the intra-region tunneling in FIG. 7B still introduces more delays than would be present if the same application server were assigned to both UE 1 and UE 2 in cluster region R1.

While FIGS. 7A and 7B are directed to conventional processes of setting up IMS service between two UEs for a 1-to-1 (or 1:1) IMS session, FIG. 7C illustrates a conventional process of setting up a group IMS session between UEs 1 . . . N where the assignment of application servers is based on location. Referring to FIG. 7C, similar to 700B of FIG. 7B, the IMS network 600 maintains a table of locations for the application servers that are available to the operator for assigning to UEs for supporting IMS service on behalf of that operator, 700B.

In FIG. 7C, assume that UEs 1 . . . N are each connected to the 3GPP RAN 120A, 705C-710C. While connected to the 3GPP RAN 120A, UEs 1 . . . 3 each transmit a request for IMS service in order to set-up or join a group IMS session between UEs 1 . . . N, 715C. The IMS network 600 receives the IMS service requests from UEs 1 . . . 3, looks up the locations of UEs 1 . . . 3 (e.g., retrievable from a presence server which tracks locations for 3GPP-connected UEs) and identifies, for each of UEs 1 . . . 3, a closest application server to be assigned to the UE based on a comparison between the UE's location and the table from 700C, 720C. In this case, assume that the IMS network 600 identifies AS 1-1 in cluster region R1 as the closest application server to UEs 1 . . . 3 at 720C, and the IMS network 600 assigns AS 1-1 to UEs 1 . . . 3 at 725C.

While connected to the 3GPP RAN 120A, UEs 4 . . . N each transmit a request for IMS service in order to join the group IMS session between UEs 2 . . . N, 730C. The IMS network 600 receives the IMS service requests from UEs 4 . . . N, looks up the locations of UEs 4 . . . N (e.g., retrievable from a presence server which tracks locations for 3GPP-connected UEs) and identifies, for each of UEs 4 . . . N, a closest application server to be assigned to the UE based on a comparison between the UE's location and the table from 700C, 735C. In this case, assume that the IMS network 600 identifies AS 1-2 in cluster region R1 as the closest application server to UEs 4 . . . . N at 735C, and the IMS network 600 assigns AS 1-2 to UEs 4 . . . N at 740C.

Based on the above-noted application server assignments for the IMS session, when one of UEs 1 . . . 3 sends data during the group IMS session at 745A, AS 1-1 sends the data to the other UEs connected to AS 1-1 without tunneling, 750C, and AS 1-1 tunnels the data via a backhaul connection to AS 1-2 for delivery to UEs 4 . . . N, 755C. Also, when one of UEs 4 . . . N sends data during the group IMS session at 760C, AS 1-2 sends the data to the other UEs connected to AS 1-2 without tunneling, 765C, and AS 1-2 tunnels the data via a backhaul connection to AS 1-1 for delivery to UEs 1 . . . 3, 770C. As will be appreciated, as more application servers are assigned to UEs participating in the group IMS session, tunneling delays increase as well as network resource consumption and session management complexity.

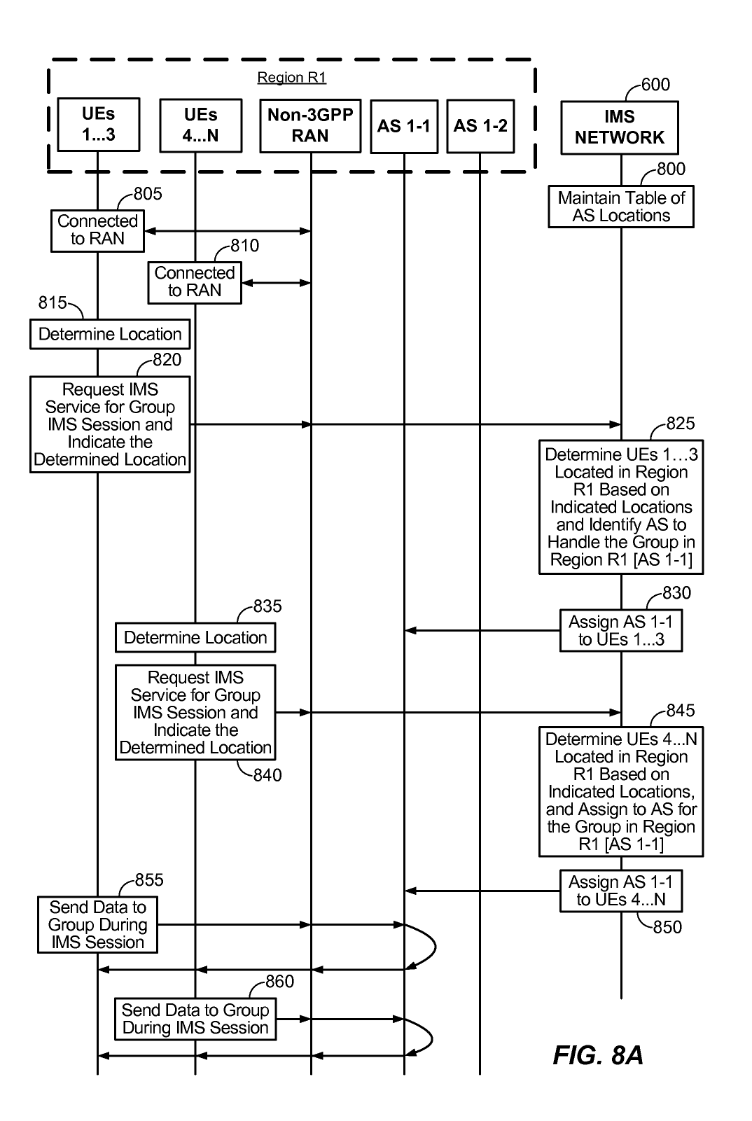

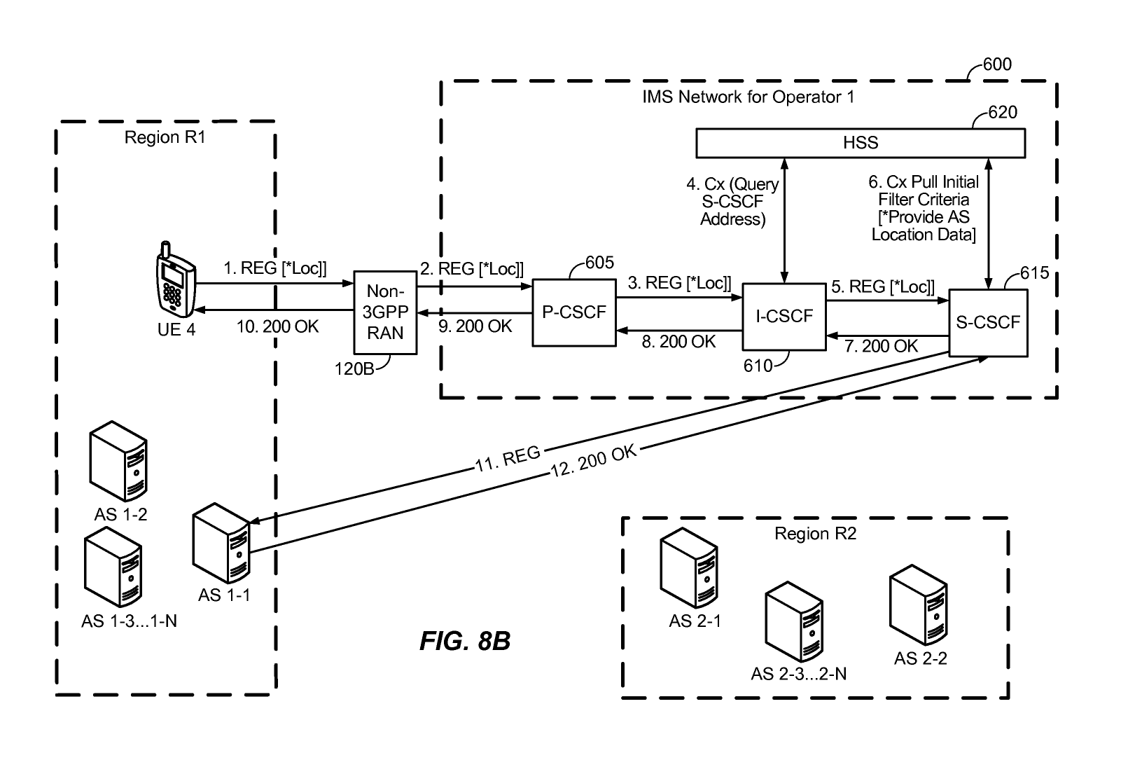

FIG. 8A illustrates a process of setting up group IMS service between UEs 1 . . . N in accordance with an embodiment of the invention. In particular, FIG. 8A is directed to a scenario whereby the IMS network 600 selects a common or shared application server for registering each UE in a group of UEs that is determined to be in a particular cluster region.

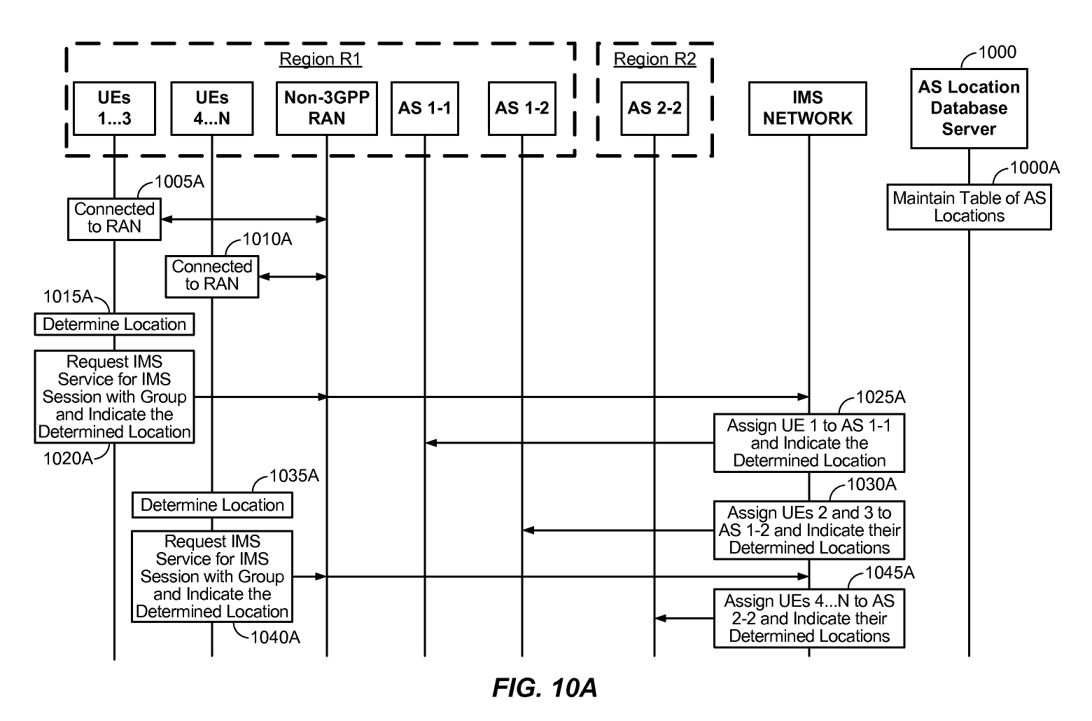

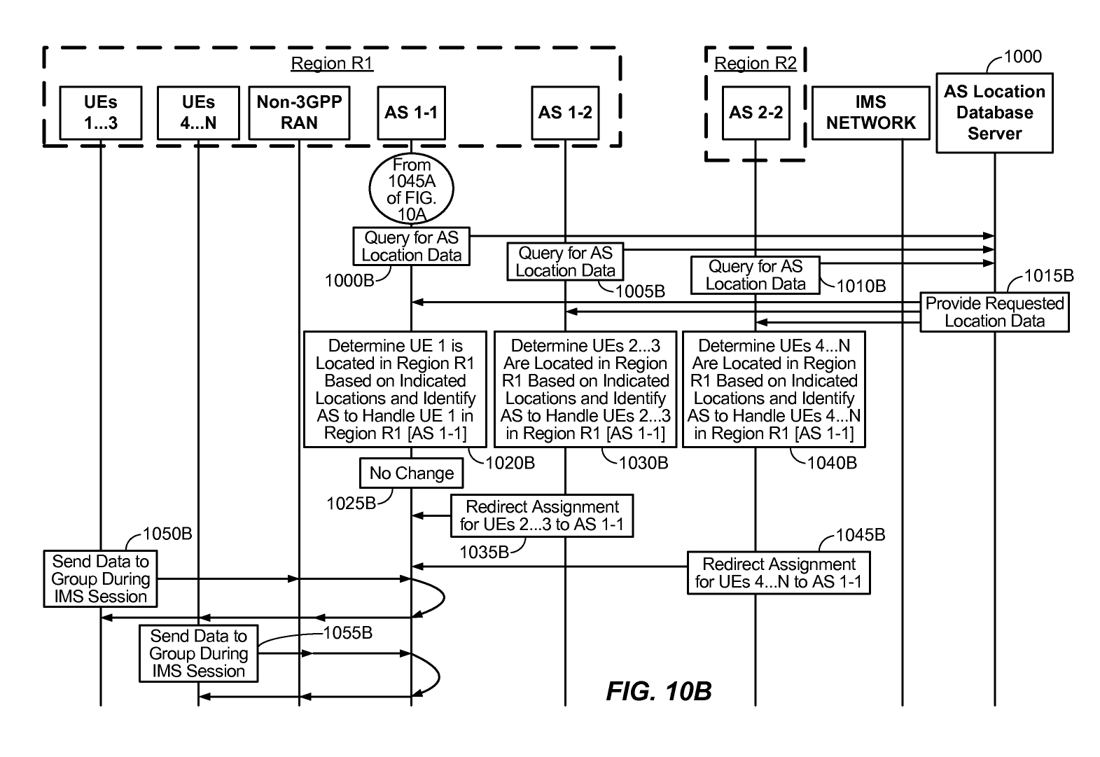

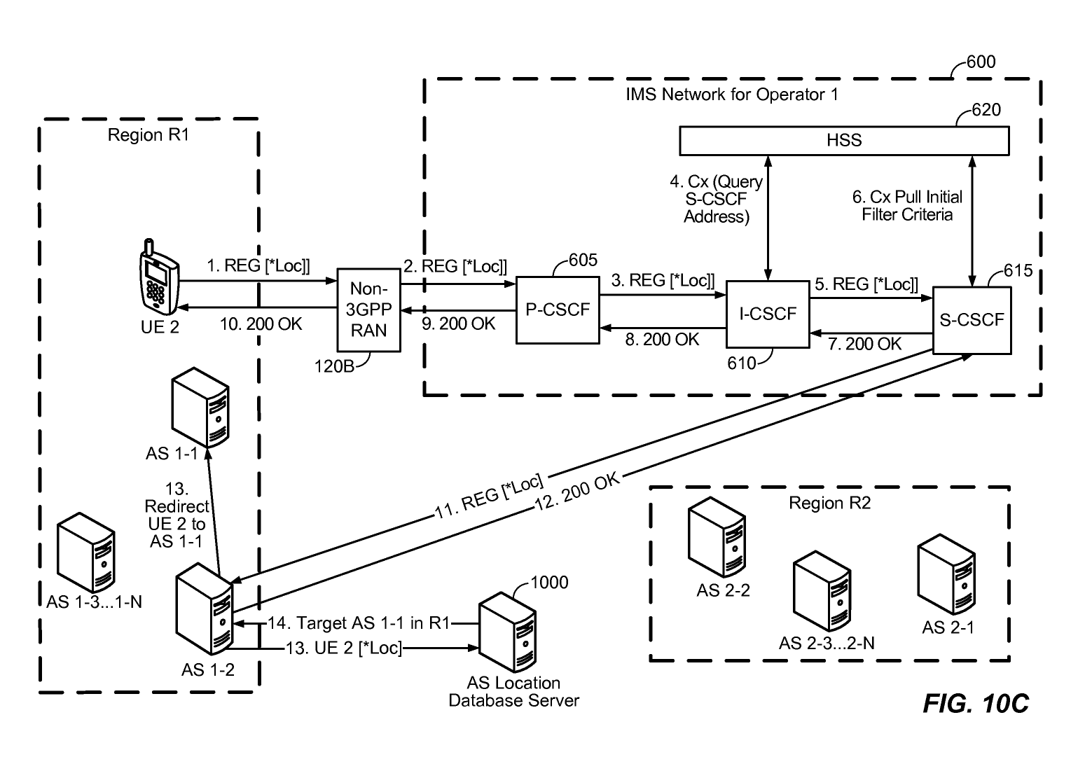

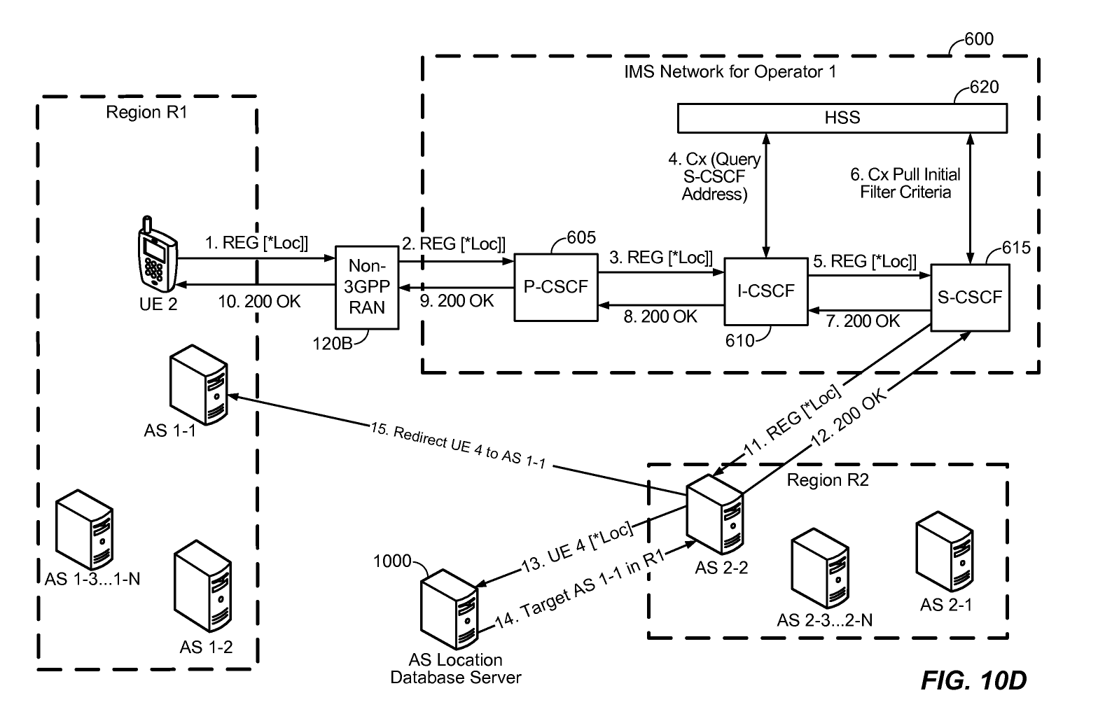

Referring to FIG. 8A, the IMS network 600 maintains a table of locations for the application servers that are available to the operator for assigning to UEs for supporting IMS service on behalf of that operator, 800. For example, the table of 800 may be maintained at the HSS 620, as will be described below with respect to FIG. 8B. Alternatively, while not shown explicitly in FIG. 8A, the table of locations for the application servers can alternatively occur at a server external to the IMS network 600 (e.g., such as the database server 1000 discussed below with respect to FIGS. 10A-10D, in which case the server location data can be retrieved by the IMS network 600 in response to a query issued by the IMS network 600 to the external server.

For convenience of explanation, FIG. 8A is illustrated and described whereby each of UEs 1 . . . N is connected to the non-3GPP RAN 120B, 805 and 810. However, in another embodiment, less than all of UEs 1 . . . N can be 3GPP-connected, such that the group IMS session is established between both 3GPP-connected and non-3GPP-connected UEs. Thereby, in an alternative embodiment, any non-3GPP UEs can omit the location-determining and conveying aspects discussed below because the IMS network 600 has other mechanisms for identifying locations of 3GPP UEs (e.g., by identifying their respective serving cells in the 3GPP RAN 120A, etc.).

Referring to FIG. 8A, while connected to the non-3GPP RAN 120B, UEs 1 . . . 3 each determine their location, 815, and each of UEs 1 . . . 3 then configures and transmits a request to register to a group IMS session between UEs 1 . . . N, 820. In an example, the requests of 820 can include an identifier of the IMS group that can be recognized by the IMS network 600 and/or an application server to which UEs 1 . . . 3 become registered. The location determination at 815 can be performed in accordance with any well-known position determination mechanism, such as GPS, forward trilateration, observing a cell or pilot identifier of a locally visible base station and so on. In a further example, the location determination of 815 can correspond to testing network propagation delays between UEs 1 . . . 3 and a set of application servers in the IMS network 600 (e.g., AS 1-1, AS 1-2, etc.), whereby the cluster region where UEs 1 . . . 3 are located can be determined based on the results of the network propagation delay tests. For instance, if the lowest network propagation delay occur between UEs 1 . . . 3 and AS 1-1 or AS 1-2, then UEs 1 . . . 3 are probably located in cluster region R1. The request at 820 can thereby explicitly indicate the locations of UEs 1 . . . 3 in an example (e.g., geographic longitude/latitude coordinates), or can implicitly indicate the locations of UES 1 . . . 3 (e.g., via identification of a serving base station, network propagation delay results, etc.).

The IMS network 600 receives the IMS registration requests from UEs 1 . . . 3, determines that the IMS registration requests are associated with the same IMS group (e.g., based on a group ID contained in the IMS service requests) and that UEs 1 . . . 3 are located in the same cluster region R1 based on their indicated locations, and the IMS network 600 identifies a single application server at which to register UEs located in cluster region R1 for the group IMS session, 825. In other words, at 825, any UE located in cluster region R1 and attempting to join the above-noted group IMS session will be assigned to the same application server. Thereby, even if another application server is physically closer to one or more of the UEs in the group IMS session or would otherwise be better suited to providing IMS service to the UEs in terms of performance, a unified application server for the group is selected for assignment at 825. In this case, assume that the IMS network 600 identifies AS 1-1 in cluster region R1 as the application server at which UEs in cluster region R1 are to be registered for the group IMS session at 825, and the IMS network 600 assigns AS 1-1 to UEs 1 . . . 3 at 830.

Referring to FIG. 8A, while connected to the non-3GPP RAN 120B, UEs 4 . . . N each determine their location 835, and each of UEs 4 . . . N then configures and transmits a request to register to the group IMS session between UEs 1 . . . N, 840. Similar to 815, the location determination at 835 can be performed in accordance with any well-known position determination mechanism, such as GPS, forward trilateration, testing network propagation delays to a set of application servers, observing a cell or pilot identifier of a locally visible base station and so on. Also, similar to 820, the requests of 840 can include an identifier of the IMS group that can be recognized by the IMS network 600 and/or an application server to which UEs 4 . . . N become registered.

The IMS network 600 receives the IMS registration requests from UEs 4 . . . N, determines that the IMS service requests are associated with the same IMS service group (e.g., based on a group ID contained in the IMS registration requests) and that UEs 4 . . . N are located in the same cluster region R1 based on their indicated locations, and the IMS network 600 identifies a single application server at which to register UEs located in cluster region R1 for the group IMS session, 845. In this case, assume that the IMS network 600 identifies AS 1-1 in cluster region R1 as the application server for the group IMS session at 845 (e.g., because AS 1-1 was already assigned to that group at 825), and the IMS network 600 assigns AS 1-1 to UEs 4 . . . N at 850.

Based on the above-noted application server assignments for the group IMS session, when one of UEs 1 . . . 3 sends data during the group IMS session at 855, AS 1-1 sends the data to the other UEs connected to AS 1-1 without tunneling to another application server. Also, when one of UEs 4 . . . N sends data during the group IMS session at 860, AS 1-1 sends the data to the other UEs connected to AS 1-1 without tunneling to another application server. Accordingly, tunneling between application servers to support UEs that are in the same cluster region can be reduced via the process of FIG. 8A. In another embodiment, it is possible that the group IMS session can be extended to include UEs that are located in other cluster regions. In this case, inter-region tunneling can be implemented, but a single application server can be allocated to the group in each cluster region so that intra-region tunneling can still be reduced. In yet another alternative embodiment, if the group IMS session is extended to include UEs that are located in other cluster regions, the same application server in cluster region R1 can be assigned to those UEs even if they are not close to cluster region R1. While this increases the propagation delays between AS 1-1 and the remote UEs, it simplifies management of the group IMS session.

FIG. 8B illustrates the process of FIG. 8A as it pertains to UE 4 being implemented over the IMS architecture from FIG. 6 in accordance with an embodiment of the invention. Referring to FIG. 8B, UE 4 transmits a REGISTER message to request registration to a group IMS session and also indicates the location of UE 4 (denoted as 'REG [*Loc] in FIG. 8B) to the non-3GPP RAN 120B (step 1, similar to 840 of FIG. 8A), the non-3GPP RAN 120B sends REG [*Loc] to the P-CSCF 605 (step 2), which selects a target I-CSCF 610 (step 3). The I-CSCF queries the HSS 620 to obtain an address for the S-CSCF 615 (step 4) and then sends REG [*Loc] to the identified S-CSCF 615 (step 5). The S-CSCF 615 obtains the IFC data from the HSS 620 (step 5), which in this case includes information pertaining to the location of the application servers in the various cluster regions of the communications network (at least, the application servers in the cluster region mapped to the location indicated by UE 4 in the REGISTER message). The S-CSCF 615 then selects the single application server for supporting the identified group IMS session based on the application server location information and the indicated location of UE 4, which in this case is AS 1-1 in cluster region R1 (e.g., as in 845 of FIG. 8A). As will be appreciated, after a single application server is already assigned to a group for a particular cluster region, the S-CSCF 615 can map subsequent UEs in the group who are in the same cluster region to the pre-selected application server (e.g., as in 845 of FIG. 8A). The S-CSCF 615 acknowledges REG [*Loc] via a 200 OK message (steps 7-10) and also sends a REGISTER message to AS 1-1 to assign UE 4 to AS 1-1 (step 11, similar to 850 of FIG. 8A), and AS 1-1 responds with a 200 OK message (step 12). Because the IMS network 600 is responsible for the application server selection, the REGISTER message sent to AS 1-1 at step 11 does not necessarily need to contain the location of UE 4, or [*Loc]. At this point, UE 4 is assigned to AS 1-1 for the group IMS session, and AS 1-1 can send a Service Available message to UE 4 (not shown).

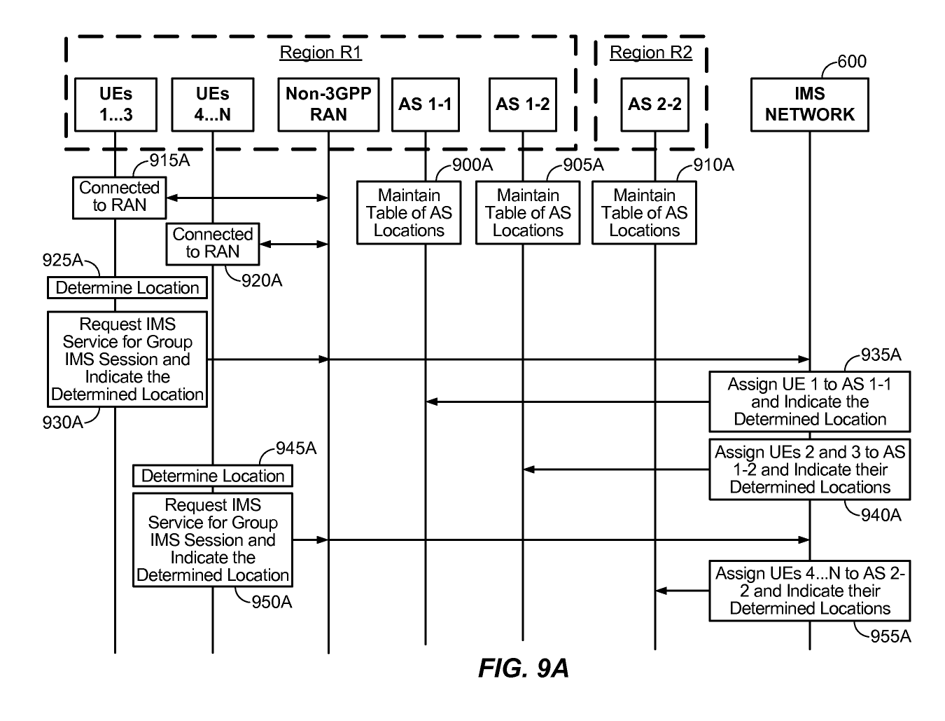

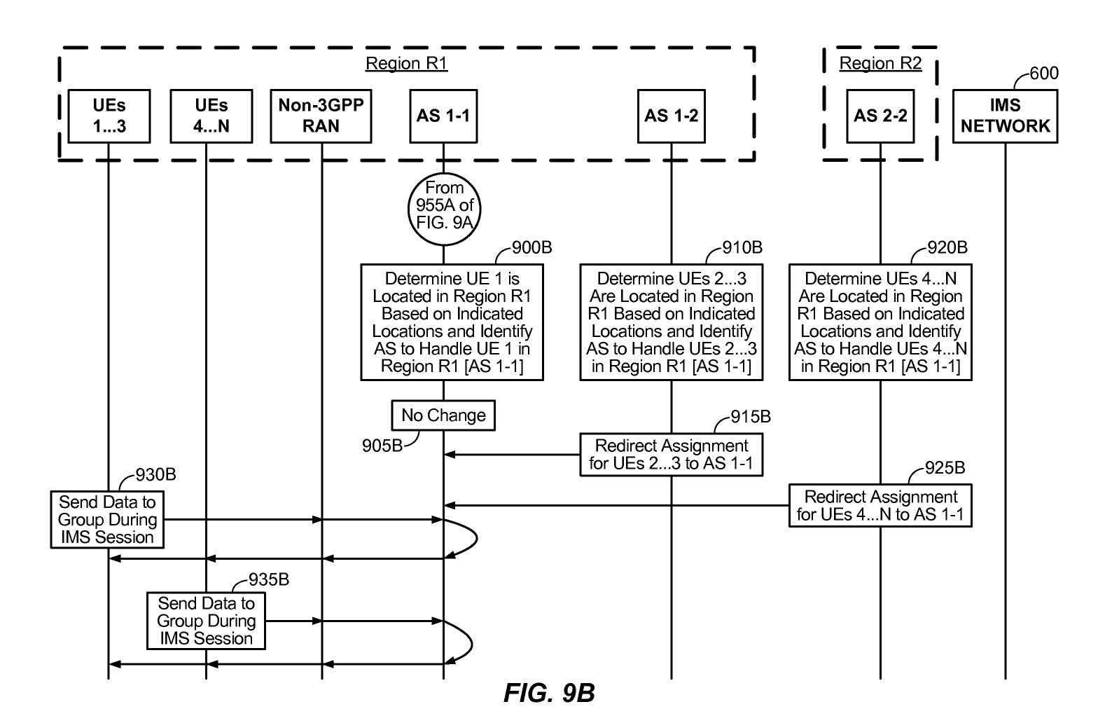

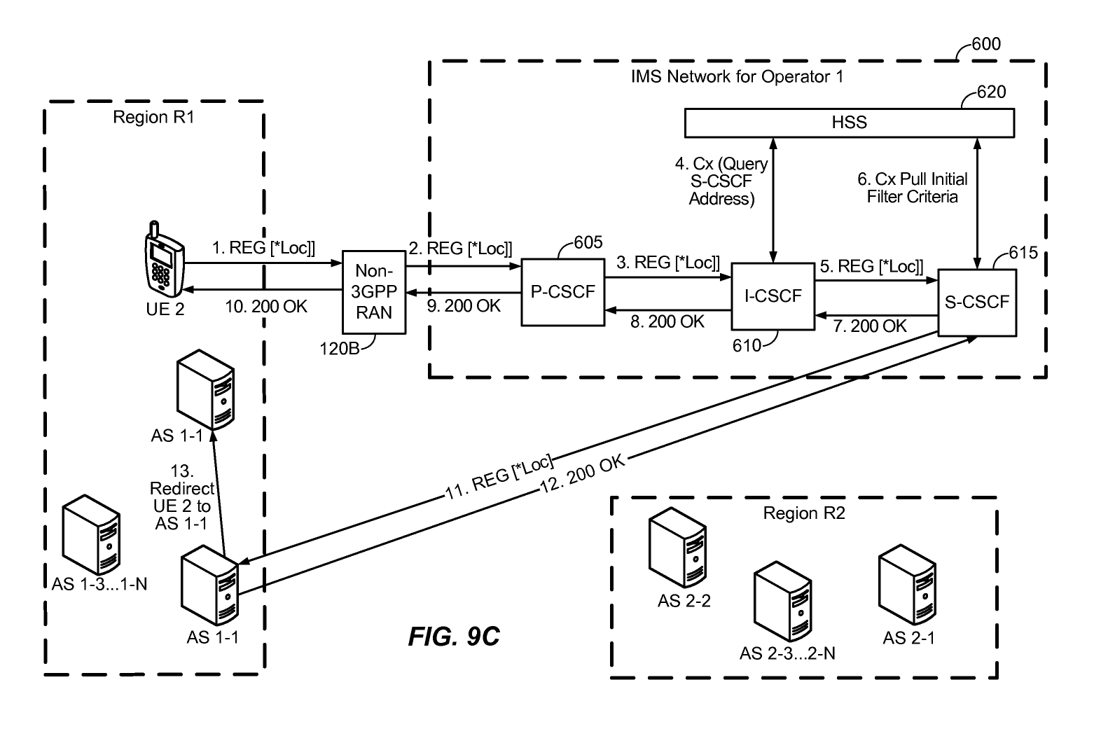

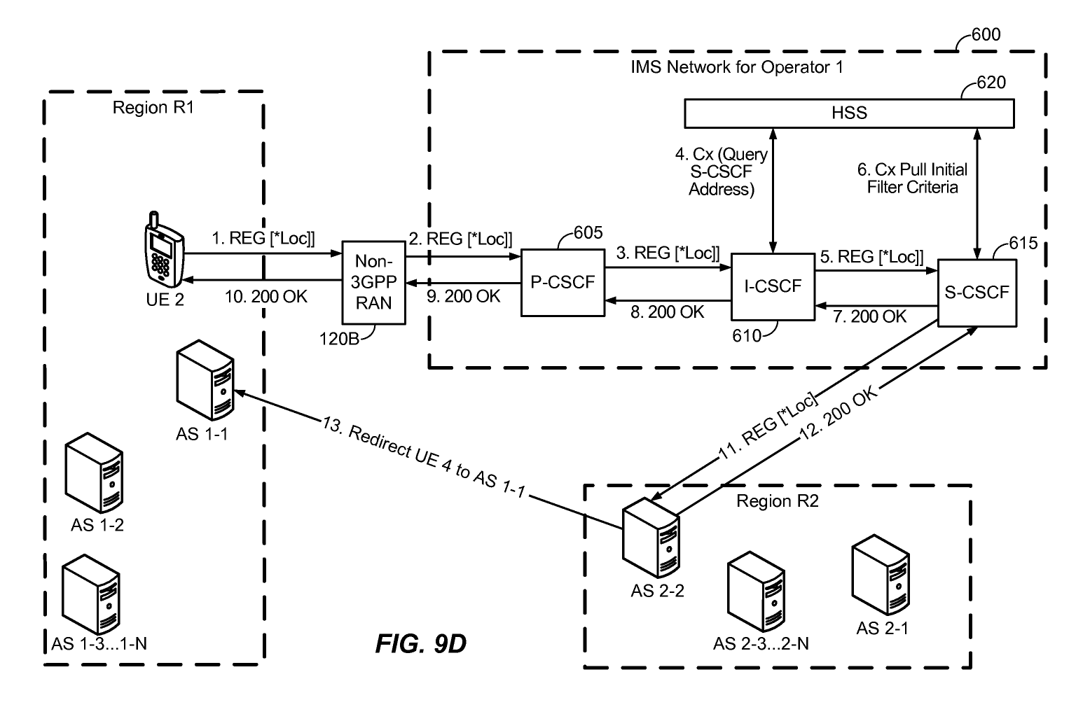

While the decision logic for selecting the target application server based on location is implemented at the IMS network 600, in another embodiment of the invention, the IMS network 600 can select the target application server to support an IMS session for a particular UE based on any selection scheme, and the decision logic for selecting a more appropriate server (if necessary) can be delegated to the target application server instead of the IMS network 600 itself. FIGS. 9A-10D thereby illustrate embodiments of server-based redirection schemes for IMS session registrations in accordance with embodiments of the invention. While the examples provided below with respect to FIGS. 9A-10D focus on group IMS sessions, this is merely to demonstrate a more complicated use-case as compared with 1:1 sessions. Accordingly, the group IMS session examples provided below are not intended to preclude implementation for 1:1 IMS sessions.

FIG. 9A illustrates a process of setting up a group IMS session between UEs 1 . . . N in accordance with an embodiment of the invention. Referring to FIG. 9A, assume that application servers AS 1-1, AS 1-2 and AS 2-2 each independently maintain a table of locations for the application servers that are available to the operator for assigning to UEs for supporting IMS sessions on behalf of that operator, 900A, 905A and 910A. In an example, the tables maintained at 900A, 905A and 910A may be maintained at each operator-affiliated or operator-controlled application server in the network that is configured to support IMS sessions across different cluster regions. Alternatively, only a subset of application servers in the network may support the application location table, in which case AS 1-1, AS 1-2 and AS 2-2 are simply members of this subset. The tables maintained at 900A, 905A and 910A may be similar to the table maintained at the IMS network 600 at 800 of FIG. 8A, in an example.

For convenience of explanation, FIG. 9A is illustrated and described whereby each of UEs 1 . . . N is connected to the non-3GPP RAN 120B, 915A and 920A. However, in another embodiment, less than all of UEs 1 . . . N can be 3GPP-connected, such that the group IMS session is established between both 3GPP-connected and non-3GPP-connected UEs. Thereby, in an alternative embodiment, any non-3GPP UEs can omit the location-determining and conveying aspects discussed below because the IMS network 600 has other mechanisms for identifying locations of 3GPP UEs (e.g., by identifying their respective serving cells in the 3GPP RAN 120A, etc.).

Referring to FIG. 9A, while connected to the non-3GPP RAN 120B, UEs 1 . . . 3 each determine their location, 925A, and each of UEs 1 . . . 3 then configures and transmits a request to register to a group IMS session between UEs 1 . . . N, 930A. In an example, the requests of 930A can include an identifier of the IMS group that can be recognized by the IMS network 600 and/or an application server to which UEs 1 . . . 3 become registered. The location determination at 925A can be performed in accordance with any well-known position determination mechanism, such as GPS, forward trilateration, observing a cell or pilot identifier of a locally visible base station and so on, similar to 815 of FIG. 8A.

The IMS network 600 receives the IMS registration requests from UEs 1 . . . 3, and assigns UEs 1 . . . 3 to application servers based on a given server selection-scheme, 935A and 940A. The server selection scheme can correspond to any well-known server selection scheme (e.g., the closest available application server to each of UEs 1.3, a randomly selected application server, an application server with the lowest load, etc.). In this case, assume that the IMS network 600 assigns UE Ito AS 1-1 and assigns UEs 2 . . . 3 to AS 1-2. Further, the assignments of 935A and 940A include a conveyance of the indicated group identifications and locations from the IMS registration requests received at 930A. As will be explained below in more detail, the assignments sent to AS 1-1 and AS 1-2 for UEs 1 . . . 3 at 935A and 940A are sufficient for AS 1-1 and AS 1-2 to determine on their own if AS 1-1 and AS 1-2 have been respectively assigned to UEs 1 . . . 3 appropriately, and if not, to trigger a UE redirect (or re-assignment) procedure.

Referring to FIG. 9A, while connected to the non-3GPP RAN 120B, UEs 4 . . . N each determine their location, 945A, and each of UEs 4 . . . N then configures and transmits a request to register to the group IMS session between UEs 1 . . . N, 950A. Similar to 840 of FIG. 8A, the location determination at 945A can be performed in accordance with any well-known position determination mechanism, such as GPS, forward trilateration, observing a cell or pilot identifier of a locally visible base station and so on.

The IMS network 600 receives the IMS registration requests from UEs 4 . . . N, and assigns UEs 4 . . . N to application servers based on the given server selection-scheme, 955A, similar to 935A and 940A, 955A. In this case, assume that the IMS network 600 assigns UEs 4 . . . N to AS 2-2 in cluster region R2, 955A. Further, similar to 935A and 940A, the assignments of 955A include a conveyance of the indicated group identifications and locations from the IMS registration requests received at 950A. As will be explained below in more detail, the assignments sent to AS 2-2 for UEs 4 . . . N at 955A are sufficient for AS 2-2 to determine on their own if AS 2-2 has been assigned to UEs 4 . . . N appropriately, and if not, to trigger a UE redirect (or re-assignment) procedure.

FIG. 9B illustrates a continuation of the process of FIG. 9A in accordance with an embodiment of the invention. Referring to FIG. 9B, AS 1-1 determines that UE 1 is located in cluster region R1 based on its indicated location from the assignment message of 935A. Optionally, AS 1-1 can also evaluate the group identifier associated with the group IMS session in order to identify a single application server in cluster region R1 for handling the group IMS session. Assume that AS 1-1 determines not to redirect UE 1 to another application server at 905B.

Referring to FIG. 9B, at 910B, AS 1-2 determines that UEs 2 . . . 3 are located in cluster region R1 based on their indicated locations from the assignment message of 940A. In the embodiment of FIG. 9B, AS 1-2 also evaluates the group identifier associated with the group IMS session in order to identify a single application server at which to register UEs located in cluster region R1 for the group IMS session, which in this case is AS 1-1, 910B. In an example, AS 1-2 can identify AS 1-1 as the server assigned to the group IMS session in cluster region R1 based upon signaling between AS 1-1 and AS 1-2. For example, AS 1-2 can ping the other servers in cluster region R1, which are identified by AS 1-2 using the application location table from 905A, with the group identifier and the server assigned to that group in cluster region R1, in this case AS 1-1, can respond to the ping. Thus, at a minimum, AS 1-2 uses its application location table to redirect UEs 2 . . . 3 to an application server in their own cluster region (which is not necessary for UEs 2 . . . 3 in this case), and optionally AS 1-2 can also attempt to redirect UEs 2 . . . 3 to a specific application server in their own cluster region similar to FIGS. 8A-8B (which in this case is AS 1-1). Thus, in other implementations, AS 1-2 could determine that multiple application servers in the same cluster region are sufficient so long as UEs are served by an application server in their own cluster region, in which case the decision logic of 910B would not result in a redirect operation. However, in the embodiment of FIG. 9B, it is assumed that AS 1-2 will attempt to perform intra-region redirects to centralize server assignments for group IMS sessions by cluster region. Thereby, AS 1-2 redirects the assignment of UEs 2 . . . 3 to AS 1-1 for the group IMS service, 915B.

Referring to FIG. 9B, at 920B, AS 2-2 determines that UEs 4 . . . N are located in cluster region R1 based on their indicated locations from the assignment messages of 950A. In the embodiment of FIG. 9B, AS 2-2 also evaluates the group identifier associated with the group IMS session in order to identify a single application server in cluster region R1 for handling the group IMS session, which in this case is AS 1-1, 920B. In an example, AS 2-2 can identify AS 1-1 as the server assigned to the group IMS session based upon signaling between AS 1-1 and AS 2-2. For example, AS 2-2 can ping servers in cluster region R1, which are identified by AS 2-2 using the application location table from 910A, with the group identifier and the server assigned to that group, in this case AS 1-1, can respond to the ping. Thus, at a minimum, AS 2-2 uses its application location table to redirect UEs 4 . . . N to an application server in their own cluster region (i.e., cluster region R1), and optionally can also attempt to redirect UEs 4 . . . N to a specific application server in their own cluster region similar to 910B-915B (which in this case is AS 1-1). Thus, in other implementations, AS 2-2 could determine to redirect UEs 4 . . . N to any application server in cluster region R1, and not necessarily AS 1-1. However, in the embodiment of FIG. 9B, it is assumed that AS 2-2 will attempt to perform redirects to centralize server assignments for group IMS sessions by cluster region. Thereby, AS 2-2 redirects the assignment of UEs 4 . . . N to AS 1-1 for the group IMS service, 925B.

Based on the above-noted application server assignments for the group IMS session, when one of UEs 1 . . . 3 sends data during the group IMS session at 930B, AS 1-1 sends the data to the other UEs connected to AS 1-1 without tunneling to another application server. Also, when one of UEs 4 . . . N sends data during the group IMS session at 935B, AS 1-1 sends the data to the other UEs connected to AS 1-1 without tunneling to another application server. Accordingly, tunneling between application servers to support UEs that are in the same cluster region can be reduced via the process of FIGS. 9A-9B. In another embodiment, it is possible that the group IMS session can be extended to include UEs that are located in other cluster regions. In this case, inter-region tunneling can be implemented, but a single application server can be allocated to the group in each cluster region so that intra-region tunneling can still be reduced. In yet another alternative embodiment, if the group IMS session is extended to include UEs that are located in other cluster regions, the same application server in cluster region R1 can be assigned to those UEs even if they are not close to cluster region R1. While this increases the propagation delays between AS 1-1 and the remote UEs, it simplifies management of the group IMS session.

FIG. 9C illustrates the process of FIGS. 9A-9B as it pertains to UE 2 being implemented over the IMS architecture from FIG. 6 in accordance with an embodiment of the invention. Referring to FIG. 9C, UE 2 transmits a REGISTER message to request registration to a group IMS session and also indicates the location of UE 2 (denoted as 'REG [*Loc] in FIG. 9C) to the non-3GPP RAN 120B (step 1, similar to 930A of FIG. 9A), the non-3GPP RAN 120B sends REG [*Loc] to the P-CSCF 605 (step 2), which selects a target I-CSCF 610 (step 3). The I-CSCF queries the HSS 620 to obtain an address for the S-CSCF 615 (step 4) and then sends REG [*Loc] to the identified S-CSCF 615 (step 5). The S-CSCF 615 obtains the IFC data from the HSS 620 (step 5), which in this case does not necessarily information pertaining to the location of the application servers in the various cluster regions of the communications network (unlike step 5 from FIG. 8B). The S-CSCF 615 then selects an application server for supporting UE 2's requested IMS session in accordance with any server selection scheme, which in this case is AS 1-2 in cluster region R1 (e.g., as described above with respect to 940A of FIG. 9A). The S-CSCF 615 acknowledges REG [*Loc] via a 200 OK message (steps 7-10) and also sends REG [*Loc] to AS 1-2 to assign UE 2 to AS 1-2 (step 11, as in 940A of FIG. 9A), and AS 1-2 responds with a 200 OK message (step 12). Unlike step 11 of FIG. 8B, the REGISTER message REG [*Loc] at step 11 indicates the location for UE 2, which permits AS 1-2 to identify a more appropriate application server for UE 2 based on its locally maintained application location database from 905A of FIG. 9A. In this case, AS 1-2 determines to redirect UE 2 to AS 1-1, which for example can be based in part upon the group identifier for UE 2's requested IMS session (e.g., as in 910B of FIG. 9B). At this point, AS 1-2 redirects UE 2 to AS 1-1 for the group IMS session (step 13, as in 915B of FIG. 9B), and AS 1-1 can send a Service Available message to UE 2 (not shown).

FIG. 9D illustrates the process of FIGS. 9A-9B as it pertains to UE 4 being implemented over the IMS architecture from FIG. 6 in accordance with an embodiment of the invention. Referring to FIG. 9D, UE 4 transmits a REGISTER message configured to request registration to a group IMS session and also indicates the location of UE 4 (denoted as 'REG [*Loc] in FIG. 9D) to the non-3GPP RAN 120B (step 1, similar to 950A of FIG. 9A), the non-3GPP RAN 120B sends REG [*Loc] to the P-CSCF 605 (step 2), which selects a target I-CSCF 610 (step 3). The I-CSCF queries the HSS 620 to obtain an address for the S-CSCF 615 (step 4) and then sends REG [*Loc] to the identified S-CSCF 615 (step 5). The S-CSCF 615 obtains the IFC data from the HSS 620 (step 5), which in this case does not necessarily information pertaining to the location of the application servers in the various cluster regions of the communications network (unlike step 5 from FIG. 8B and similar to step 5 from FIG. 9C). The S-CSCF 615 then selects an application server for supporting UE 4's requested IMS session in accordance with any server selection scheme, which in this case is AS 2-2 in cluster region R2 (e.g., as described above with respect to 955A of FIG. 9A). The S-CSCF 615 acknowledges REG [*Loc] via a 200 OK message (steps 7-10) and also sends REG [*Loc] to AS 2-2 to assign UE 4 to AS 2-2 (step 11, as in 955A of FIG. 9A), and AS 2-2 responds with a 200 OK message (step 12). Unlike step 11 of FIG. 8B and similar to step 11 of FIG. 9C, the REGISTER message REG [*Loc] at step 11 indicates the location for UE 4, which permits AS 2-2 to identify a more appropriate application server for UE 4 based on its locally maintained application location database from 910A of FIG. 9A. In this case, AS 2-2 determines to redirect UE 4 to AS 1-1 within cluster region 1, which for example can be based in part upon the group identifier for UE 4's requested IMS session (e.g., as in 920B of FIG. 9B). At this point, AS 2-2 redirects UE 4 to AS 1-1 for the group IMS session (step 13, as in 925B of FIG. 9B), and AS 1-1 can send a Service Available message to UE 4 (not shown).

FIGS. 10A-10D are similar to FIGS. 9A-9D, respectively, except that the responsibility for tracking application server locations in FIGS. 10A-10D is centralized in a single database server 1000 instead of requiring each application server to independently track application server locations. As will be appreciated, the distributed approach of FIGS. 9A-9D permits IMS sessions to be set-up more quickly because the amount of external signaling is reduced, while the centralized approach in FIGS. 10A-10D is simpler to implement because each application server does not need to independently track the locations of the application servers. In another embodiment, the database server 1000 can be implemented in a system where some application servers maintain application server location tables as in FIGS. 9A-9B while others do not, so that the application servers that do not maintain application server location tables can contact the database server 1000 to acquire application server location data while the application servers that maintain application server location tables can operate as described above with respect to AS 1-1, AS 1-2 and AS 2-2 in FIGS. 9A-9D.

Referring to FIG. 10A, the database server 1000 maintains the table of application server locations at 1000A such that AS 1-1, AS 1-2 and AS 2-2 do not need to perform this operation as in 900A, 905A and 910A, respectively, of FIG. 9A. Thereafter, 1005A through 1045A correspond to 915A through 955A of FIG. 9A, respectively, and will not be discussed in more detail for the sake of brevity.

Referring to FIG. 10B, after AS 1-1, AS 1-2 and AS 2-2 receive their respective registration requests (or assignments) for UEs 1 . . . N for the group IMS session at 1025A, 1030A and 1045A, respectively, and AS 1-1, AS 1-2 and AS 2-2 query the database server 1000 for server-specific location data, 1000B, 1005B and 1010B. At 1015B, the database server 1000 responds to the queries by providing AS 1-1, AS 1-2 and AS 2-2 with the requested server-specific location data. For example, the queries of 1000B, 1005B and 1010B can provide (or indicate) the locations of UEs 1 . . . N that are attempting to be registered to the group IMS service, and the database server 1000 can provide information pertaining to the application servers in the same cluster region as the UE registrants at 1015B. At this point, AS 1-1, AS 1-2 and AS 2-2 have obtained the same server location data that was used for by AS 1-1, AS 1-2 and AS 2-2 to execute the redirect decision logic from 900B, 905B and 910B, respectively. Accordingly, 1020B through 1055B correspond to 900B through 935B of FIG. 9B, respectively, and will not be discussed in more detail for the sake of brevity.

Referring to FIG. 10C, steps 1 through 12 and 15 substantially correspond to steps 1 through 13, respectively, of FIG. 9C. At step 14, AS 1-2 queries the database server 1000 for the server-specific location data (e.g., as in 1005B of FIG. 10B), and at step 15, the database server 1000 provides the requested server-specific location data (e.g., as in 1015B of FIG. 10B).

Referring to FIG. 10D, steps 1 through 12 and 15 substantially correspond to steps 1 through 13, respectively, of FIG. 9D. At step 14, AS 2-2 queries the database server 1000 for the server-specific location data (e.g., as in 1010B of FIG. 10B), and at step 15, the database server 1000 provides the requested server-specific location data (e.g., as in 1015B of FIG. 10B).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of operating an Internet Protocol (IP) multimedia subsystem (IMS) network that is operated by a single operator, comprising:
receiving, from a user equipment (UE) that is connected to a non-cellular access network, a request to register to a group IMS session;
obtaining location information associated with the UE that indicates that the UE is operating in a given location region from a plurality of location regions;
identifying, from among a plurality of application servers deployed throughout the plurality of location regions and configured to provide IMS service on behalf of the single operator, two or more application servers that are deployed in the given location region;
determining that any UE requesting registration to the group IMS session and located in the given location region is to be registered to a single application server that is selected from the two or more identified application servers; and
registering the UE with the selected single application server based on the determination.

2. The method of claim 1, further comprising:
receiving, from another UE that is connected either to the non-cellular access network or a cellular access network, another request to register to the group IMS session;
obtaining location information associated with the another UE that indicates that the another UE is operating in the given location region; and
registering the another UE with the selected single application server based on the determination.

3. The method of claim 1, wherein the receiving, obtaining, identifying, determining and registering steps are performed at a serving call session control function (S-CSCF) of the IMS network.

4. The method of claim 1,
wherein the selected single application server is not a closest application server to the UE from among the two or more identified application servers, and
wherein the registering of the UE with the selected single application server occurs despite the selected single application server not being the closest application server in order to concentrate registrations to the group IMS session for UEs within the given location region to the selected single application server.

5. The method of claim 1, wherein the location information is obtained from a home subscriber server (HSS) of the IMS network that is configured to maintain a table that tracks where the plurality of a plurality of applications for the single operator are deployed among the plurality of location regions.

6. The method of claim 1, wherein the location information is obtained from a server that is external to the IMS network and is configured to maintain a table that tracks where the plurality of a plurality of applications for the single operator are deployed among the plurality of location regions.

7. The method of claim 1, wherein the location information associated with the UE corresponds to an indication of geographic location of the UE that is contained within the request to register to the group IMS session.

8. The method of claim 1,
wherein the location information corresponds to results of tested network propagation delays between the UE and the plurality of application servers and the given location region corresponds to a location region where an application server with a lowest of the tested network propagation delays is deployed.

9. The method of claim 1, wherein the request to register to the group IMS session is a REGISTER message.

10. The method of claim 1, wherein the non-cellular access network corresponds to an IEEE 802 network.

11. The method of claim 10, wherein the IEEE 802 network is a WiFi network or IEEE 802.11 network.

12. The method of claim 1, wherein the determination of the single selected application server is based at least in part upon a loading level at the two or more application servers.

13. The method of claim 12, wherein the selected single application server corresponds to a given application server with a lowest loading level among the two or more application servers.

14. A method of operating an application server that is configured to provide Internet Protocol (IP) multimedia subsystem (IMS) service on behalf of a single operator and is deployed within a first location region of a communications network, comprising:
receiving, from an IMS network, a request to register a user equipment (UE) that is connected to a non-cellular access network to an IMS session;
obtaining location information associated with the UE that indicates that the UE is operating in a second location region that is different from the first location region;
querying an application server location database to identify a set of application servers that are configured to provide IMS service on behalf of the single operator and are deployed within the second location region;
selecting, from the identified set of application servers, a different application server at which to register the UE for the IMS session; and
redirecting registration of the UE for the IMS session from the application server to the selected different application server.

15. The method of claim 14,
wherein the IMS session is a group IMS session, and
wherein the selected different application server to which the UE is redirected corresponds to a single application server at which any UEs located in the second location region are to be registered for the group IMS session.

16. The method of claim 14, wherein the application server location database is independently maintained by the application server.

17. The method of claim 14, wherein the application server location database is maintained at an external server that is separate from the application server.

18. The method of claim 14, wherein the location information associated with the UE corresponds to an indication of geographic location of the UE that is contained within the request to register to the IMS session.

19. The method of claim 14,
wherein the location information corresponds to results of tested network propagation delays between the UE and a plurality of application servers and the second location region corresponds to a location region where an application server with a lowest of the tested network propagation delays is deployed.

20. The method of claim 14, wherein the request to register to the IMS session is a REGISTER message.

21. The method of claim 14, wherein the non-cellular access network corresponds to an IEEE 802 network.

22. The method of claim 21, wherein the IEEE 802 network is a WiFi network or IEEE 802.11 network.

23. A method of operating an application server that is configured to provide Internet Protocol (IP) multimedia subsystem (IMS) service on behalf of a single operator and is deployed in a given location region of a communications network, comprising:
receiving, from an IMS network, a request to register a user equipment (UE) that is connected to a non-cellular access network to a group IMS session;
obtaining location information associated with the UE that indicates that the UE is operating in the given location region;
determining that any UE requesting registration to the group IMS session and located in the given location region is to be registered to a single application server that is different from the application server; and
redirecting registration of the UE for the group IMS session from the application server to the different application server.

24. The method of claim 23, further comprising:
querying an application server location database to identify a set of application servers other than the application server that are configured to provide IMS service on behalf of the single operator and are deployed within the given location region; and
selecting, from the identified set of application servers, the different application server at which to register the UE for the group IMS session.

25. The method of claim 24, wherein the application server location database is independently maintained by the application server.

26. The method of claim 24, wherein the application server location database is maintained at an external server that is separate from the application server.

27. The method of claim 24,
wherein the different application server is not a closest application server to the UE from among the identified set of application servers, and
wherein the redirection of the UE to the different application server occurs despite the different application server not being the closest application server in order to concentrate registrations to the group IMS session for UEs within the given location region to the different application server.

28. The method of claim 23, wherein the location information associated with the UE corresponds to an indication of geographic location of the UE that is contained within the request to register to the group IMS session.

29. The method of claim 23,
wherein the location information corresponds to results of tested network propagation delays between the UE and a plurality of application servers and the given location region corresponds to a location region where an application server with a lowest of the tested network propagation delays is deployed.

30. The method of claim 23, wherein the request to register to the group IMS session is a REGISTER message.

31. The method of claim 23, wherein the non-cellular access network corresponds to an IEEE 802 network.

32. The method of claim 31, wherein the IEEE 802 network is a WiFi network or IEEE 802.11 network.

33. An Internet Protocol (IP) multimedia subsystem (IMS) network that is operated by a single operator, comprising:
means for receiving, from a user equipment (UE) that is connected to a non-cellular access network, a request to register to a group IMS session;
means for obtaining location information associated with the UE that indicates that the UE is operating in a given location region from a plurality of location regions;
means for identifying, from among a plurality of application servers deployed throughout the plurality of location regions and configured to provide IMS service on behalf of the single operator, two or more application servers that are deployed in the given location region;
means for determining that any UE requesting registration to the group IMS session and located in the given location region is to be registered to a single application server that is selected from the two or more identified application servers; and
means for registering the UE with the selected single application server based on the determination.

34. An application server that is configured to provide Internet Protocol (IP) multimedia subsystem (IMS) service on behalf of a single operator and is deployed within a first location region of a communications network, comprising:
means for receiving, from an IMS network, a request to register a user equipment (UE) that is connected to a non-cellular access network to an IMS session;
means for obtaining location information associated with the UE that indicates that the UE is operating in a second location region that is different from the first location region;
means for querying an application server location database to identify a set of application servers that are configured to provide IMS service on behalf of the single operator and are deployed within the second location region;
means for selecting, from the identified set of application servers, a different application server at which to register the UE for the IMS session; and
means for redirecting registration of the UE for the IMS session from the application server to the selected different application server.

35. An application server that is configured to provide Internet Protocol (IP) multimedia subsystem (IMS) service on behalf of a single operator and is deployed in a given location region of a communications network, comprising:
means for receiving, from an IMS network, a request to register a user equipment (UE) that is connected to a non-cellular access network to a group IMS session;
means for obtaining location information associated with the UE that indicates that the UE is operating in the given location region;
means for determining that any UE requesting registration to the group IMS session and located in the given location region is to be registered to a single application server that is different from the application server; and
means for redirecting registration of the UE for the group IMS session from the application server to the different application server.

36. An Internet Protocol (IP) multimedia subsystem (IMS) network that is operated by a single operator, comprising:
logic configured to receive, from a user equipment (UE) that is connected to a non-cellular access network, a request to register to a group IMS session;
logic configured to obtain location information associated with the UE that indicates that the UE is operating in a given location region from a plurality of location regions;
logic configured to identify, from among a plurality of application servers deployed throughout the plurality of location regions and configured to provide IMS service on behalf of the single operator, two or more application servers that are deployed in the given location region;
logic configured to determine that any UE requesting registration to the group IMS session and located in the given location region is to be registered to a single application server that is selected from the two or more identified application servers; and
logic configured to register the UE with the selected single application server based on the determination.

37. An application server that is configured to provide Internet Protocol (IP) multimedia subsystem (IMS) service on behalf of a single operator and is deployed within a first location region of a communications network, comprising:
logic configured to receive, from an IMS network, a request to register a user equipment (UE) that is connected to a non-cellular access network to an IMS session;
logic configured to obtain location information associated with the UE that indicates that the UE is operating in a second location region that is different from the first location region;
logic configured to query an application server location database to identify a set of application servers that are configured to provide IMS service on behalf of the single operator and are deployed within the second location region;
logic configured to select, from the identified set of application servers, a different application server at which to register the UE for the IMS session; and
logic configured to redirect registration of the UE for the IMS session from the application server to the selected different application server.

38. An application server that is configured to provide Internet Protocol (IP) multimedia subsystem (IMS) service on behalf of a single operator and is deployed in a given location region of a communications network, comprising:
logic configured to receive, from an IMS network, a request to register a user equipment (UE) that is connected to a non-cellular access network to a group IMS session;
logic configured to obtain location information associated with the UE that indicates that the UE is operating in the given location region;
logic configured to determine that any UE requesting registration to the group IMS session and located in the given location region is to be registered to a single application server that is different from the application server; and
logic configured to redirect registration of the UE for the group IMS session from the application server to the different application server.

39. A non-transitory computer-readable medium containing instructions stored thereon, which, when executed by an Internet Protocol (IP) multimedia subsystem (IMS) network that is operated by a single operator, cause the IMS network to perform operations, the instructions comprising:
at least one instruction causing the IMS network to receive, from a user equipment (UE) that is connected to a non-cellular access network, a request to register to a group IMS session;
at least one instruction causing the IMS network to obtain location information associated with the UE that indicates that the UE is operating in a given location region from a plurality of location regions;
at least one instruction causing the IMS network to identify, from among a plurality of application servers deployed throughout the plurality of location regions and configured to provide IMS service on behalf of the single operator, two or more application servers that are deployed in the given location region;
at least one instruction causing the IMS network to determine that any UE requesting registration to the group IMS session and located in the given location region is to be registered to a single application server that is selected from the two or more identified application servers; and
at least one instruction causing the IMS network to register the UE with the selected single application server based on the determination.

40. A non-transitory computer-readable medium containing instructions stored thereon, which, when executed by an application server that is configured to provide Internet Protocol (IP) multimedia subsystem (IMS) service on behalf of a single operator and is deployed within a first location region of a communications network, cause the application server to perform operations, the instructions comprising:
at least one instruction causing the application server to receive, from an IMS network, a request to register a user equipment (UE) that is connected to a non-cellular access network to an IMS session;
at least one instruction causing the application server to obtain location information associated with the UE that indicates that the UE is operating in a second location region that is different from the first location region;
at least one instruction causing the application server to query an application server location database to identify a set of application servers that are configured to provide IMS service on behalf of the single operator and are deployed within the second location region;
at least one instruction causing the application server to select, from the identified set of application servers, a different application server at which to register the UE for the IMS session; and
at least one instruction causing the application server to redirect registration of the UE for the IMS session from the application server to the selected different application server.

41. A non-transitory computer-readable medium containing instructions stored thereon, which, when executed by an application server that is configured to provide Internet Protocol (IP) multimedia subsystem (IMS) service on behalf of a single operator and is deployed within a given location region of a communications network, cause the application server to perform operations, the instructions comprising:
at least one instruction causing the application server to receive, from an IMS network, a request to register a user equipment (UE) that is connected to a non-cellular access network to a group IMS session;
at least one instruction causing the application server to obtain location information associated with the UE that indicates that the UE is operating in the given location region;
at least one instruction causing the application server to determine that any UE requesting registration to the group IMS session and located in the given location region is to be registered to a single application server that is different from the application server; and
at least one instruction causing the application server to redirect registration of the UE for the group IMS session from the application server to the different application server.
